(19) United States
(12) Patent Application Publication
(10) Pub. No.: US 2025/0126637 A1
(43) Pub. Date: Apr. 17, 2025

(54) DYNAMIC SUB-CHANNEL PRE-ALLOCATION

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Rubayet Shafin, Allen, TX (US); Peshal Nayak, Plano, TX (US); Yue Qi, Plano, TX (US); Elliot Jen, Taipei City (TW)

(21) Appl. No.: 18/902,835

(22) Filed: Sep. 30, 2024

Related U.S. Application Data
(60) Provisional application No. 63/544,082, filed on Oct. 13, 2023.
(60) Provisional application No. 63/564,350, filed on Mar. 12, 2024.
(60) Provisional application No. 63/658,631, filed on Jun. 11, 2024.
(60) Provisional application No. 63/659,620, filed on Jun. 13, 2024.

(51) Int. Cl. H04W 74/04; H04W 76/15

(52) U.S. Cl. CPC H04W 74/04; H04W 76/15

(57) ABSTRACT

An access point (AP) in a wireless network, the AP comprising a memory and a processor coupled to the memory, the processor is configured obtain a transmission opportunity (TXOP) or service period (SP), transmit, to a first station (STA) during the TXOP or the SP, an indication allocating a first subchannel to the first STA at a first transmission start time, wherein the first subchannel is out of an operating channel width of the first STA, transmit, to the second STA, an indication allocating a second subchannel to the second STA at a second transmission start time, transmit, to the first STA during the TXOP or the SP on the first subchannel, a first frame at the first transmission start time, and transmit, to the second STA during the TXOP or the SP on the second subchannel, a second frame at the second transmission start time.

### CROSS-REFERENCE TO RELATED APPLICATIONS

This application claims the benefit of priority from U.S. Provisional Application No. 63/544,082, entitled “Method and Apparatus for Dynamic Sub-Channel Pre-Allocation” filed Oct. 13, 2023, U.S. Provisional Application No. 63/564,350, entitled “Dynamic Sub-Channel Pre-Allocation” filed Mar. 12, 2024, U.S. Provisional Application No. 63/658,631 entitled “Dynamic Sub-Channel Pre-Allocation” filed Jun. 11, 2024, and U.S. Provisional Application No. 63/659,620 entitled “Dynamic Sub-Channel Pre-Allocation” filed Jun. 13, 2024, all of which are incorporated herein by reference in their entireties.

### TECHNICAL FIELD

This disclosure relates generally to a wireless communication system, and more particularly to, for example, but not limited to, dynamic sub-channel pre-allocation.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network. The AP comprises a memory, and a processor coupled to the memory. The processor is configured to obtain a transmission opportunity (TXOP) or service period (SP). The processor is configured to transmit, to a first station (STA) during the TXOP or the SP, an indication allocating a first subchannel among one or more subchannels to the first STA at a first transmission start time, wherein the first subchannel is out of an operating channel width of the first STA. The processor is configured to transmit, to a second STA during the TXOP or the SP, an indication allocating a second subchannel among the one or more subchannels to the second STA at a second transmission start time, wherein the second subchannel is out of an operating channel width of the second STA. The processor is configured to transmit, to the first STA during the TXOP or the SP on the first subchannel, a first frame at the first transmission start time. The processor is configured to transmit, to the second STA during the TXOP or the SP on the second subchannel, a second frame at the second transmission start time.

In some embodiments, the processor is further configured to receive a third frame, from the first STA, wherein the third frame includes information associated with at least one of: a capability of supporting allocation of a subchannel outside of the operating channel width of the first STA, or a channel switch time required by the first STA to switch to an allocated channel, wherein the first transmission start time is determined based on the channel switch time.

In some embodiments, the indications allocating the first subchannel and the second subchannel are transmitted within a third frame, where the processor is further configured to, at a beginning of the TXOP or the SP, transmit the third frame indicating at least one of: one or more identifiers of associated STAs the AP intends to serve within the TXOP or the SP, a transmission start time applicable to each of the identified one or more STAs, an allocation of a sub-channel for transmission of a response to the third frame, if the response is solicited from the one or more identified STAs, allocations of one or more sub-channels allocated to each of the one or more identified STAs for transmissions within the TXOP or the SP, allocations of one or more 20 MHZ channels to be used for preamble detection by each of the one or more identified STAs, or a switch back time after which the one or more identified STAs are expected to return to a primary channel.

In some embodiments, the processor is further configured to: transmit, to a third STA during the TXOP or the SP, an indication allocating the second subchannel among the one or more subchannels to the third STA at the first transmission start time, and transmit, to the third STA during the TXOP or the SP on the second subchannel, a third frame at the first transmission start time.

In some embodiments the processor is further configured to, before the first transmission start time, transmit one or more of: a padding field within a third frame, wherein the third frame includes the indication allocating the first subchannel to the first STA, a fourth frame, wherein the fourth frame includes the indication allocating the second subchannel among the one or more subchannels to the second STA, or a fifth frame, wherein the fifth frame is a data frame or a null data packet with padding.

In some embodiments, the processor is further configured to end frame transmissions to the one or more STAs before the end of the TXOP to enable the one or more STAs to switch back to the primary channel.

In some embodiments, the processor is further configured to transmit a third frame to indicate a capability to support allocation of a subchannel outside of an operating channel width of an associated STA, wherein the associated STA can be allocated one or more subchannels of the TXOP or the SP that are outside of the associated STA's operating channel width.

In some embodiments, a third STA is operating in enhanced multi-link single radio (EMLSR) mode or enhanced multi-link multi-radio (EMLMR) mode, wherein the processor is configured to: exclude the third STA from operation on a subchannel outside of an operating channel width of the third STA, or determine a transmission start time for the third STA based on a channel switch time required by the third STA and a padding delay required by the third STA for EMLSR or EMLMR operation, and transmit an indication of a subchannel allocation to the third STA in an EMLSR or EMLMR control frame.

In some embodiments, the indication allocating the first subchannel among the one or more subchannels to the first STA is included in a third frame, wherein the third frame comprises at least one of: whether the first subchannel can be used by the first STA for peer-to-peer transmissions, a duration for which the first subchannel can be used for peer-to-peer transmissions, an identifier of other STA allocated to the same subchannel by the AP, or a transmit power and modulation and coding scheme restrictions applicable for the peer-to-peer transmissions.

One aspect of the present disclosure provides a non-access point (AP) station (STA) in a wireless network. The non-AP STA comprising a memory, and a processor coupled to the memory. The processor is configured to transmit, to an AP, a first frame indicating a capability to operate one or more subchannels out of the primary channel. The processor is configured to receive, during a TXOP or SP, a second frame from the AP that indicates a subchannel allocation and a transmission start time. The processor is configured to switch to the indicated subchannel before the transmission start time, wherein the indicated subchannel is outside of the operating channel width of the non-AP STA.

In some embodiments, the processor is further configured to receive, on the subchannel starting at the transmission start time, frames from the AP.

In some embodiments, the processor is further configured to transmit to the AP a third frame indicating at least one of: enablement or disablement of supporting operation on a subchannel outside of the operating channel width by the non-AP STA, one or more supported subchannels outside the operating channel width by the non-AP STA, bandwidth, spatial stream and modulation and coding scheme supported by the non-AP STA when receiving transmissions outside the operating channel width, or capability of the non-AP STA to be pre-allocated a subchannel, wherein the transmission start time to the non-AP STA may not be immediately after the indication of the allocation.

In some embodiments, the processor is further configured to, upon receiving the second frame, immediately switching to the indicated subchannel or switching to the indicated subchannel at or before the transmission start time.

In some embodiments, the processor is further configured to switch back to a primary channel based on at least one of: an indication of the end of the TXOP or the SP time and the channel switch time needed by the non-AP STA to switch channels, a detection of the indicated subchannel to be idle for more than a threshold time after the indicated transmission start time, a detection of a particular frame on the indicated subchannel that corresponds to another basic service set (BSS) or that the transmit address or receive address of the particular frame does not correspond to the AP, or a determination that no frames are received from the AP within a threshold time after the indicated start time.

In some embodiments, the process is further configured to perform preamble detection on a 20 MHz channel that is determined based on the subchannel allocated to the non-AP STA.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a channel access procedure on a secondary channel via channel bonding in accordance with an embodiment.

FIG. 5 illustrates a extremely high throughput (EHT) Operation element transmitted by an AP in accordance with an embodiment.

FIG. 6 illustrates a high throughput (HT) Operation element transmitted by an AP in accordance with an embodiment.

FIG. 7 illustrates a very high throughput (VHT) Capabilities element transmitted by an AP in accordance with an embodiment.

FIG. 8 illustrates a high efficiency multi-user physical layer protocol data unit (HE MU PPDU) format in accordance with an embodiment.

FIG. 9 illustrates a multi-user request to send (MU-RTS) Trigger frame format in accordance with an embodiment.

FIG. 10 illustrates different elements and fields used for subchannel specific transmission (SST) negotiation in accordance with an embodiment.

FIG. 11 illustrates an example of wasted basic service set (BSS) bandwidth when all associated STAs only support a narrow bandwidth in accordance with an embodiment.

FIG. 12 illustrates STAs performing subchannel switch within a transmission opportunity (TXOP) based on pre-allocation from the AP in accordance with an embodiment

FIG. 13 illustrates a dynamic subchannel operation (DSO) Capability element indication by a STA/MLD in accordance with an embodiment.

FIG. 14 illustrates a DSO Mode Notification frame in accordance with an embodiment.

FIG. 15 illustrates two different mechanisms for sub-channel allocation for STAs that are served within the TXOP in accordance with an embodiment.

FIG. 16 illustrates an example of the subchannel allocation using a Action No Ack frame in accordance with an embodiment.

FIG. 17 illustrates an example of the subchannel allocation using a Delayed ACK Trigger frame in accordance with an embodiment.

FIG. 18 illustrates an example of the subchannel allocation using a No ACK Trigger frame in accordance with an embodiment.

FIG. 19 illustrates an example illustration a Common Info field in accordance with an embodiment.

FIG. 20 illustrates using subchannel allocation frames or data frames to protect the channel switch time required by STAs in accordance with an embodiment.

FIG. 21 illustrates the benefits of using separate Subchannel Allocation frames for the STAs in accordance with an embodiment.

FIG. 22 illustrates a flow chart of an example processes by an AP for supporting DSO operation with pre-allocation in accordance with an embodiment.

FIG. 23 illustrates a flow chart of an example process performed by a non-AP STA for operating in DSO mode with pre-allocation in accordance with an embodiment.

FIG. 24 illustrates sub-channel allocation by the AP in the beginning of a TXOP to all the DSO STAs that are served within the TXOP in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

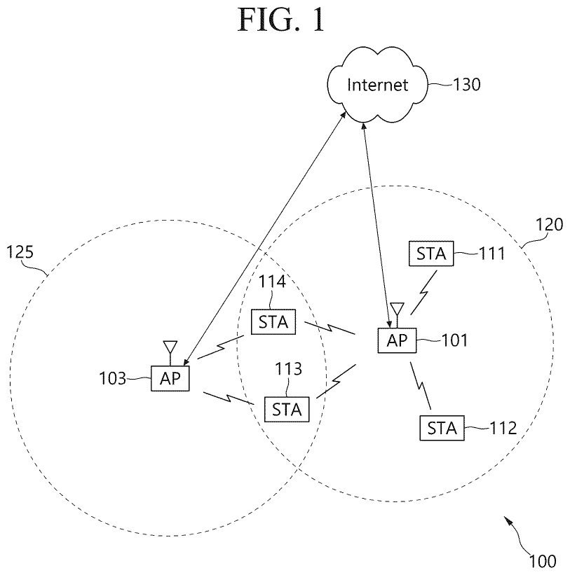

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

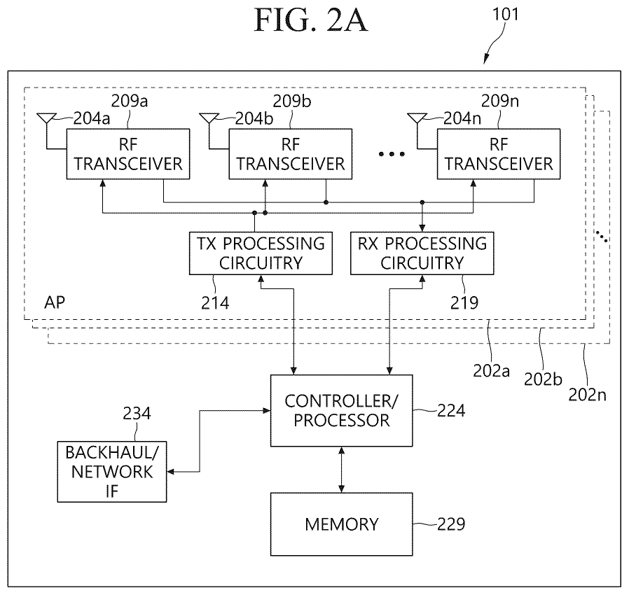

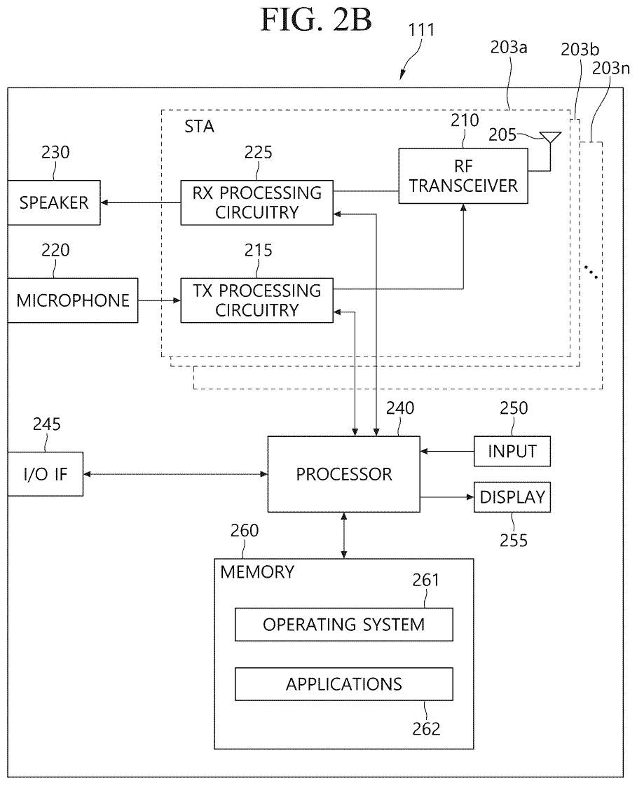

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

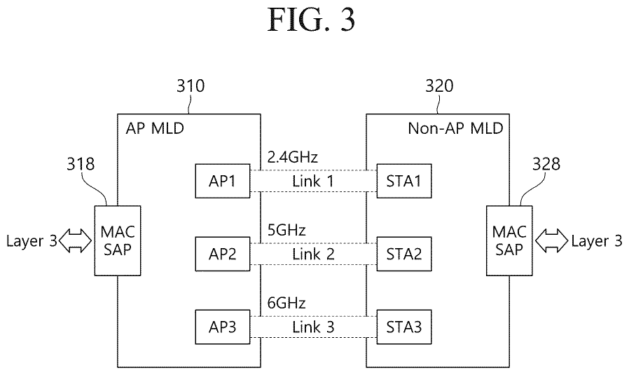

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated

STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Before the IEEE 802.11n Wi-Fi standard (up to 802.11g), Wi-Fi devices were only allowed to use up to 20 MHz of operating bandwidth. With the IEEE 802.11n standard, the concept of channel bonding was introduced to improve throughput, where a wireless device can opportunistically bond a non-primary channel along with a primary 20 MHz channel to transmit packets with a higher bandwidth. The IEEE 802.11n standard considered bonding up to 40 MHz. The IEEE 802.11ac standard expanded channel bonding up to 80 and 160 MHz. The IEEE 802.11ax standard expanded channel bonding up to 160 MHz and introduced the idea of puncturing. The IEEE 802.11be standard introduced channel bonding up to 320 MHz and further developed the puncturing concept to more configurations. The benefits of channel bonding are two-fold. In particular, if a neighbor BSS is idle, there may be a clear benefit of increased throughput. However, if a neighbor BSS has traffic, channel bonding can cause a neighbor BSS to be unable to access the channel by taking away its primary channel. However, channel bonding may improve transmission efficiency (and hence throughput), at the cost of increased latency.

Before performing a transmission on a 20 MHz or wider channel, a Wi-Fi device may need to perform the clear channel assessment (CCA) procedure to determine if a channel is ‘BUSY’ or ‘IDLE’. There are two mechanisms to perform CCA which are CCA preamble detection (CCA PD) and CCA energy detection (CCA ED). The CCA PD detects a channel as being BUSY when it observes a preamble on that channel that can be used to set the NAV time. The CCA ED detects a channel BUSY condition when the received signal strength exceeds the CCA-ED threshold as given by dot11OFDMEDThreshold for the primary 20 MHz channel, dot11OFDMEDThreshold for the secondary 20 MHZ channel (if present), dot11OFDMEDThreshold+3 dB for the secondary 40 MHZ channel (if present), and dot11OFDMEDThreshold+6 dB for the secondary 80 MHz channel (if present). Otherwise, the channel is detected as IDLE.

When a STA supports multiple channel widths, an EDCA TXOP may be obtained based solely on the activity of the primary channel. This TXOP may be won by the conventional random backoff procedure. Once an EDCA TXOP has been obtained using the IDLE state of the primary channel, a wider bandwidth transmission may be used during the TXOP based on the state of CCA on secondary channel, secondary 40 MHz channel, or secondary 80 MHz channel, etc. A wider bandwidth transmission is allowed if the secondary channel is idle during an interval of point coordination function (PCF) interframe space (PIFS) preceding start of the TXOP on the primary channel.

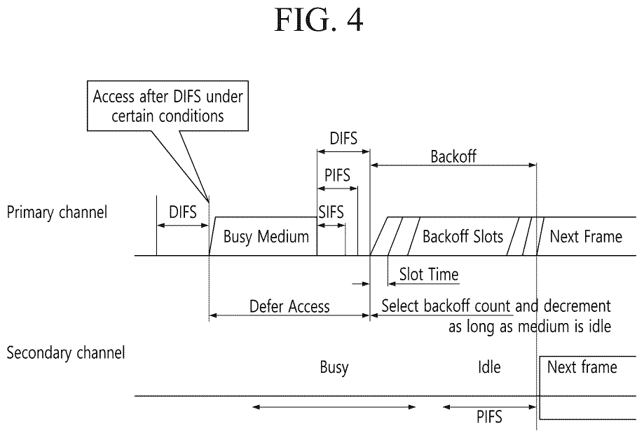

Since the bandwidth of a transmitted frame can be opportunistically increased by channel bonding, to enable reception of the transmitted frame, the preamble may be usually duplicated on all the 20 MHz bands used for transmission. It should be noted that the primary 20 MHz channel may always be used for transmission. In fact, the management and control frames may always be transmitted on the primary 20 MHz channel and may be duplicated on other secondary channels (in a duplicate PPDU format). Upon receiving the transmitted physical layer (PHY) preamble overlapping the primary 20 MHz channel, the PHY of any receiving Wi-Fi STA measures a receive signal strength. The PHY indicates this activity to the MAC by issuing a PHY-CCA.indication primitive. A PHY-CCA.indication (BUSY, channel-list) primitive is also issued as an initial indication of reception of a signal. After the PHY-CCA.indication (BUSY, channel-list) primitive is issued, the PHY entity begins receiving the training symbols and searching for L-SIG in order to set the maximum duration of the data stream. After receiving a valid L-SIG and VHT-SIG-A indicating a supported mode, the PHY entity begins receiving the very high throughput short training field (VHT-STF), very high throughput long training field (VHT-LTFs) and very high throughput signal B (VHT-SIG-B). Following training and signal fields, the Data field is received which can occupy a wider bandwidth. The signal A (SIG-A) field of the preamble is used by the receiver to know what all bands have to be demodulated using fast Fourier transform (FFT) on the data field. The PHY shall not issue a PHY-RXSTART.indication primitive in response to a PPDU that does not overlap the primary 20 MHz channel, as illustrated in FIG. 4 in accordance with an embodiment.

FIG. 4 illustrates a channel access procedure on a secondary channel via channel bonding in accordance with an embodiment. In particular, a wider bandwidth transmission is allowed if the secondary channel is idle during an interval of short interframe space (SIFS), PIFS, or DCF interframe space (DIFS) preceding start of the TXOP on the primary channel.

With channel bonding, an AP can support one or more of the following maximum bandwidths (BW) of operation: X=20, 40, 80, 160 or 320 MHz etc. The AP indicates its current operating channel's parameters using one or more of the very high throughput (VHT), high efficiency (HE), or extremely high throughput (EHT) Operation elements. An AP includes these Operating elements in Beacons and/or Probe response frames, and these elements may include: (i) a Channel Width subfield to indicate the maximum BSS bandwidth X, (ii) a Channel Center Frequency Segment (CCFS) 0 field to indicate the center frequency of the primary X/2 MHZ channel for the BSS and (iii) a CCFS 1 field to indicate the center frequency of the X MHz channel.

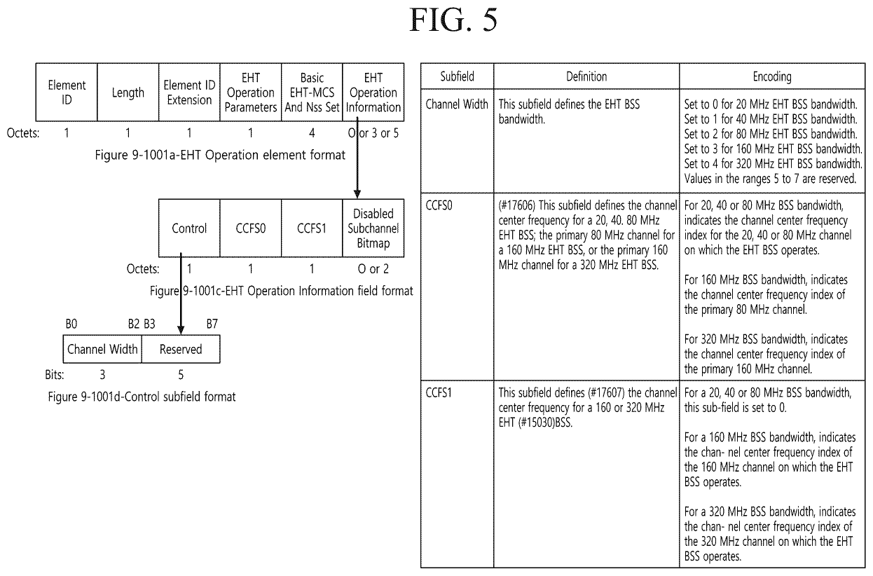

FIG. 5 illustrates an EHT Operation element transmitted by an AP in accordance with an embodiment. The EHT Operation element may include an Element ID field, a Length field, an Element ID Extension field, an EHT Operation Parameters field, a Basic EHT-MCS and Nss Set field, an EHT Operation Information field. The EHT Operation Information field may include a Control field, a CCFSO field a CCFSI field, a Disabled Subchannel Bitmap field. The Control field may include a Channel Width field and a reserved field.

The Element ID field may provide an identifier of the element. The Length field may include length information of the element. The Element ID Extension field may include extension information for the element. The EHT Operation Parameters field may include operation parameters for the element. The Basic-EHT-MCS and Nss Set field may include MCS and Nss information for the element. The EHT Operation Information field may include operation information for the element.

The Control field may include control information for the element and can include the Channel Width field and a Reserved field. The Channel Width field may provide channel width information and may define the EHT BSS bandwidth. The Reserved field may be reserved.

The CCFSO field may define the channel center frequency for a 20, 40, 80 MHz EHT BSS, the primary 80 MHz channel for a 160 MHz EHT BSS, or the primary 160 MHz channel for a 320 MHz EHT BSS. The CCFSI field may define the channel center frequency for a 160 or 320 MHz EHT BSS. The Disabled Subchannel Bitmap may provide bitmap information for the disabled subchannels.

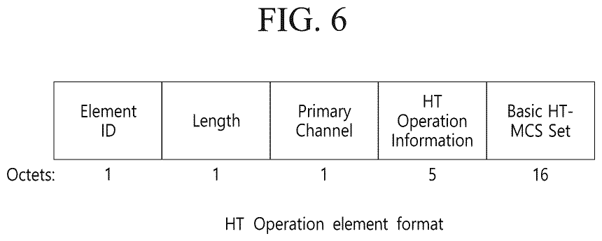

Although an AP can support a wider bandwidth than 20 MHz, an AP may also define a primary 20 MHz channel, which is a common channel of operation for all associated STAs, and whose IDLE state is a prerequisite for transmission on any secondary channel. This primary channel is indicated in the Primary Channel field of the HT Operation element that the AP transmits in Beacons and Probe response frames. An illustration of the HT Operation element is depicted in FIG. 6 in accordance with an embodiment.

FIG. 6 illustrates an HT Operation element transmitted by an AP in accordance with an embodiment. The HT Operation element may include an Element ID field, a Length field, a Primary Channel field, an HT Operation Information field, and a Basic HT-MCS Set field. The Element ID field may include an identifier of the element. The Length field may provide length information for the element. The Primary Channel field may indicate a primary channel. The HT Operation Information field may provide HT operation information. The Basic HT-MCS Set field may provide the MCS values that are supported by all HT STAs in the BSS.

An EHT STA that associates with an AP can determine the channelization of the AP's basic service set (BSS) using the combination of the information in the HT+VHT+HE+EHT Operation elements that it receives from the AP. The values of the BSS parameters may be calculated as:

$$\frac{X}{2} MHz Primary channel center freq . [ MHz ] = Channel start freq . + 5 \times CCFS 0$$

$$X MHz channel center freq . [ MHz ] = Channel start freq . + 5 \times CCFS 1$$

$$Primary 20 MHz center freq . [ MHz ] = Channel start freq . + 5 \times Primary Channel$$

$$where Channel start freq . is determined by the operating class of the BSS .$$

Although the Operation element indicates the maximum supported bandwidth of the AP, the AP also supports STAs with smaller operating bandwidths. A EHT AP/STA declares the channel widths at which it is capable of operating on, in the PHY Capabilities Information field of the HT/VHT/HE/EHT Capabilities elements that it transmits in Beacon and Probe response frames.

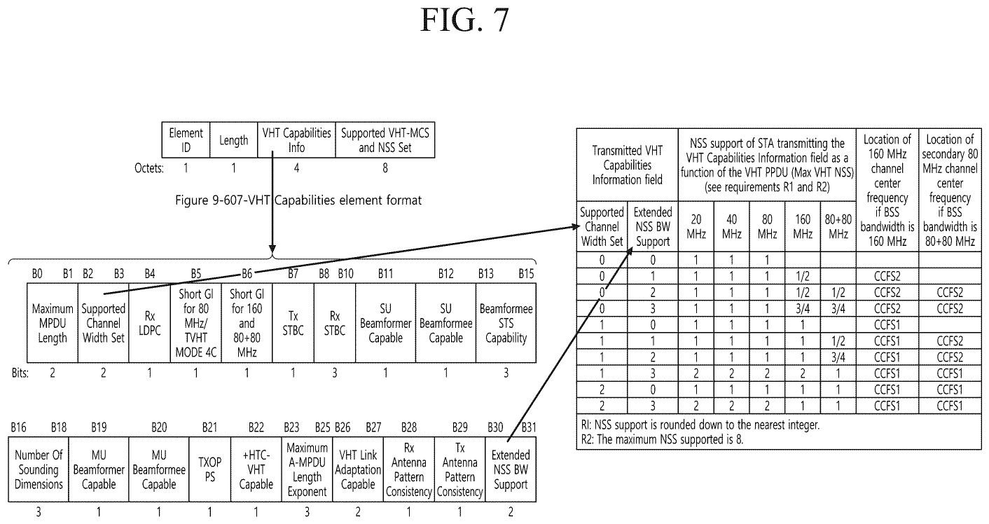

FIG. 7 illustrates a VHT Capabilities element transmitted by an AP in accordance with an embodiment 7. In particular, the NSS that can be supported at all BWs may be indicated in the Supported VHT-MCS and NSS Set field. NSS Supported for each BW is identified from the ‘Supported Channel Width Set’+ ‘Extended NSS BW Support’ fields.

In particular, the VHT Capabilities element may include an Element ID field, a Length field, a VHT Capabilities Info field, and a Supported VHT-MCS and NSS Set field. The Element ID field may provide an identifier of the element. The Length field may provide length information for the element. The VHT Capabilities Info field may provide capabilities information for the element and can include several subfields as described below. The Supported VHT-MCS and NS SSEt field may provide information on the NSS that can be supported at all BWs.

The VHT Capabilities Info field can include several subfields, including a Maximum MPDU Length field, a Supported Channel Width Set field, a RX LDPC field, a Short Gl for 160 and 80+80 MHz field, a Tx STBC field, a Rx STBC field, a SU Beamformer Capable field, a SU Beamformee Capable field, a Beamformee STA Capability field, a Number of Sounding Dimensions field, a MU Beamformer Capable field, an MU Beamformee Capable field, a TXOP PS field, a +HTC-VHT Capable field, a Maximum A-MPDU Length Exponent field, a VHT Link Adaptation Capable field, a Rx Antenna Pattern Consistency field, a Tx Antenna Patter Consistency field, a Tx Antenna Patter Consistency field, and an Extended NSS BW Support field.

The Maximum MPDU Length field may provide information regarding a maximum length of the MPDU. The Supported Channel Width Set field may provide supported channel width set information.

The Rx LDPC field provide information regarding a receiver low-density parity-check (LDPC) and may be set to 1 if the transmitter can receive LDPC-encoded frame.

The Short GI for 80 MHz/TVHT Mode 4C field provides information on a short guard interval and may be set to 1 if the transmitter can receive frames transmitted using the short guard interval with the indicated channel bandwidth.

The Short GI for 160 and 80+80 MHz field may provide information on a short guard interval and may be set to 1 if the transmitter can receive frames transmitted using the short guard interval with the indicated channel bandwidth.

The Tx STBC field may be set to 1 to indicate that transmission of STBC-coded frames is supported.

The Rx STBC field may describe how many spatial streams are supported for reception of STBC-coded frames. It may be set to 0, 1, 2, 3, or 4, describing the maximum number of spatial streams supported on reception. For support of one spatial stream, the field may take the value 1. The value 0 may be used to indicate that STBC is not supported, and the values 5-7 may be reserved

The single-user (SU) Beamformer Capable field, when set to 1, may indicate that the transmitter is capable of operating as a single-user beamformer that exchanges packets with one other station.

The SU Beamformee Capable field, when set to 1, may indicate that the transmitter is capable of operating as a single-user beamformee that exchanges packets with one other station.

The Beamformee STS Capability field may provide STA capability information on the beamformee.

The Number of Sounding Dimensions field may be used in the channel measurement process for beamforming to indicate the maximum number of antennas that can participate in channel measurement.

The MU Beamformer Capable field may provide information regarding capabilities of the MU Beamformer.

The MU Beamformee Capable field may provide information regarding capabilities of the MU Beamformee.

The TXOP PS field is a TXOP power save (PS) field, where an AP can set this bit to 1 to enable power save operations during a VHT transmission burst, or 0 to disable them. Stations associating with a network will set this bit to 1 to indicate the capability is enabled or 0 if it is disabled.

The +HTC-VHT Capable field may be set to 1 to indicate that the transmitter is capable of receiving the VHT-variant HT Control field.

The Maximum A-MPDU Length Exponent field can take on the values 0-7 and may be used to communicate the size of the A-MPDU that may be transmitted.

The VHT Link Adaption Capable field may be used for link adaptation feedback to select the most appropriate MCS for a link using explicit feedback.

The Rx Antenna Pattern Consistency field may be set to 1 if the antenna pattern of the transmitter does not change after association completes, and 0 otherwise.

The Tx Antenna Pattern Consistency field may be set to 1 if the antenna pattern of the transmitter does not change after association completes, and 0 otherwise.

The Extended NSS BW Support field may provide extended NSS BW support information.

Since the IEEE 802.11ax standard, an AP can perform downlink (DL) multi-user (MU) transmission to STAs. DL MU transmission allows an AP to simultaneously transmit information to more than one non-AP STA. For a DL MU transmission, the AP uses the HE MU PPDU format and employs either DL orthogonal frequency-division multiple access (OFDMA), DL multi-user multiple input multiple output (MU-MIMO), or a mixture of both. The transmission within any resource unit (RU) in a PPDU may be a single stream to one user (SISO), multiple streams spatially multiplexed to one user (SU-MIMO), or multiple streams spatially multiplexed to multiple users. In a HE MU PPDU, an AP informs the STAs of their RU allocations in the SIG-B field.

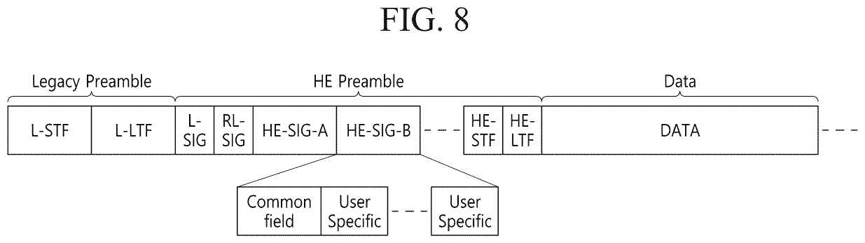

FIG. 8 illustrates an HE MU PPDU format in accordance with an embodiment. As illustrated in FIG. 8, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload).

The L-STF field may include a short training orthogonal frequency division multiplexing (OFDM) symbol. The L-STF field may be used for frame detection, automatic gain control (AGC), diversity detection, and coarse frequency/time synchronization.

The L-LTF field may include a long training orthogonal frequency division multiplexing (OFDM) symbol. The L-LTF field may be used for fine frequency/time synchronization and channel prediction.

The L-SIG field may be used for transmitting control information. The L-SIG may include information regarding a data rate and a data length.

The HE-SIG-A field may include the control information common to the receiving station. The HE-SIG-B field may include one or two HE-SIG-B fields, with each conveying user allocation for one or more 20 MHz subchannels. A HE MU PPDU with greater than 20 MHZ PPDU bandwidth may have two HE-SIG-B content channels. The Common field of an HE-SIG-B may include information regarding the RU assignment, the RUs allocated for MU-MIMO and the number of users in MU-MIMO allocations. The SIG-B User Specific fields may include information for all users in the PPDU on how to decode their payload.

The HE-STF field may be used for improving automatic gain control estimation in a multiple input multiple output (MIMO) environment or an OFDMA environment. The HE-LTF field may be used for estimating a channel in the MIMO environment or the OFDMA environment. The Data field may include data for the HE MU PPDU.

Each RU in a HE MU PPDU can be assigned for: individually addressed frames (STA_ID=AID [11:0]), broadcast frames for associated STAs (STA_ID=0) or unassociated STAs (STA_ID=2045) or can be unassigned (STA_ID=2046). An HE AP does not allocate an RU outside of the primary X MHz in a HE MU PPDU or HE TB PPDU to an X MHz operating non-AP STA if the non-AP STA has not set up Subchannel Specific Transmission (SST).

To support DL OFDMA and UL OFDMA procedure, in the IEEE 802.11ax standard, a procedure called multi-user request-to-send (MU-RTS) trigger frame was introduced. It is used to solicit a clear-to-send (CTS) response from at least one of multi-user capable STAs that are addressed by the MU-RTS frame. The MU-RTS is transmitted as a broadcast frame and in the legacy non-HT duplicate PPDU format so that all STAs are able to decode it. The MU-RTS-CTS procedure is used to prevent hidden node issues and for reserving the channel for MU transmissions. In each 20 MHz channel where TXOP is won, the AP sends a MU-RTS trigger and requests at least one non-AP STA should respond with a CTS on each such 20 MHz channel. The AP waits for a CTSTimeout interval to see if a response is obtained, if no response is obtained the AP assumes the MU-RTS has failed and may initiate a PIFS recovery or may backoff.

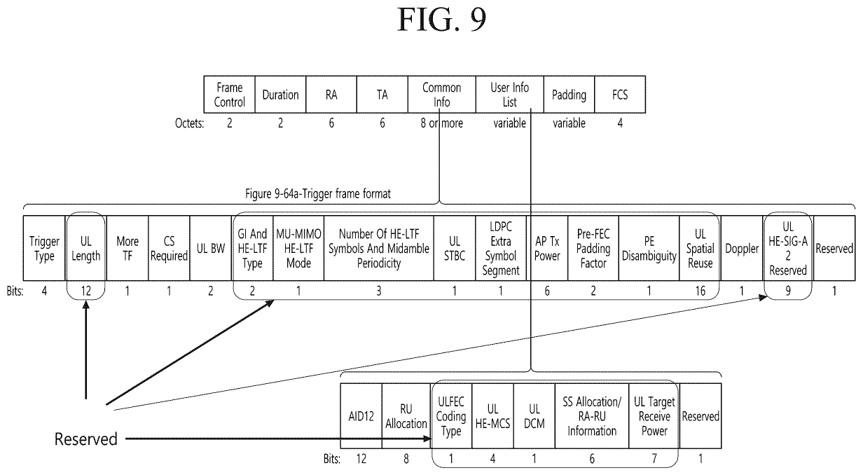

FIG. 9 illustrates an MU-RTS Trigger frame format in accordance with an embodiment. In particular, as shown in FIG. 9, the MU-RTS has a Common Info field and a User Info field. The Common Info field indicates parameters that are common to all the addressed STAs, such as the bandwidth of the TXOP and how each STA should respond to the MU-RTS frame. The User Info field may include RU Allocation to one or more AIDs. Bits B0-B7 of RU Allocation indicate the location of the X MHz primary channel where the CTS should be sent. After successful reception of the CTSs, the AP may transmit a HE TB PPDU. The UL BW field of Common Info field of MU-RTS indicates the BW of the TB PPDUs that follow.

In FIG. 9, the MU-RTS Trigger frame includes a Frame Control field, a Duration field, a Receiver Address (RA) field, a Transmitter Address (TA) field, a Common Info field, a User Info List field, a Padding field, and a FCS field.

The Frame Control field provides frame control information for the frame including version, type, subtype, among other information. The Duration field provides duration information. The RA field provides the address of the recipient STA. The TA field provides the address of the transmitting STA. The Common Info field provides parameters that are common to all the addressed STAs, and includes various subfields as described below. The User Info List field provide RU allocation to one or more AIDs, and include several subfields as described below.

The Common Info field may include a Trigger Type field, a UL Length field, a More TF field, a CS Required field, a UL BW field, a GI and HE-LTF Type field, a MU-MIMO HE-LTF Mode field, a Number of HE-LTF Symbols and Mid-Amble Periodicity field, a UL STBC field, a LDPC Extra Symbol Segment field, a AP TX Power field, a Pre-FEC Padding Factor field, a PE Disambiguity field, a UL Spatial Reuse field, a Doppler field, a UL HE-SIG-A2 Reserved field, and a Reserved field.

The User Info List field may include a AID12 field, a RU Allocation field, a UL FEC Coding Type field, a UL HE-MCS field, a UL DCM field, a SS Allocation/RA-RU Information field, a UL Target Receive Power field, and a Reserved field.

The Trigger Type field may provide information regarding a type of the trigger frame. The UL Length field may provide length information. The More TF field may provide more trigger frame information. The CS Required field may enable/disable the CS required. It is set to On to indicate that the STAs identified in the Per User Info fields are required to use ED to sense the medium and to consider the medium state and the NAV in determining whether or not to respond. The CS Required subfield is set to Off to indicate that the STAs identified in the Per User Info fields are not required consider the medium state or the NAV in determining whether or not to respond.

The UL BW field sets the bandwidth of the PPDU. The GI and HE-LTF Type field sets the GI and LTF type of the PPDU. The MU-MIMO HE-LTF Mode field provides the LTF mode information. The Number of HE-LTF Symbols and Mid-Amble Periodicity field sets the number of LTF symbols present in the HE trigger-based PPDU response. The UL STBC field may enable/disable the STBS encoding of the HE trigger-based PPDU response. The LDPC Extra Symbol Segment field may enable/disable the LDPC extra symbol segment. IT may be set to On when the LDPC extra symbol segment is present and set to Off otherwise. The AP TX Power field may set the combined average power per 20 MHz bandwidth of all transmit antennas used to transmit the trigger frame at the HE AP. Valuc 0 to 60 maps to −20 dBm to 40 dBm with 1 dB resolution. The Pre-FEC Padding Factor field may provide padding factor information. The PE Disambiguity field may provide disambiguity information. The UL Spatial Reuse field may set the value for the spatial reuse field in the HE-SIG-A field of the HE trigger-based PPDU transmitted as a response to the trigger frame. The Doppler field may indicate a high Doppler mode of transmission. The UL HE-SIG-A 2 Reserved field may set the value of the reserved bits in HE-SIG-A2 of the HE trigger-based PPDU transmitted as a response to the trigger frame. The Reserved field may be reserved. The User Info List field may include several subfields as described.

The AID12 field may set the least significant 12 bits of the AID of the STA for which the User Info field is intended. The RU Allocation field may set the RU allocation used by the HE trigger-based PPDU of the STA identified by the AID12 subfield. The UL FEC Coding Type field may set the code type of the HE trigger-based PPDU response of the STA identified by the AID 12 subfield, 0 for BCC and 1 for LDPC. The UL HE-MCS field may set the MCS of the HE trigger-based PPDU response of the STA identified by the AID12 subfield. The UL DCM field may set the dual carrier modulation of the HE trigger-based PPDU response of the STA identified by the AID12 subfield. The SS Allocation/RA-RU Information field may set the spatial streams of the HE trigger-based PPDU response of the STA identified by the AID12 subfield, 3 bits for starting spatial stream, 3 bits for spatial stream number. The UL Target Receive Power field, may set the target received signal power of the HE trigger-based PPDU response of the STA identified by the AID12 subfield. The Reserved field may be reserved.

Subchannel specific transmission (SST) is an optional feature for the AP and non-AP STA introduced in IEEE 802.11-2020 standard, that allows a non-AP STA to negotiate operating on a specific band during a trigger enabled Target Wake Time (TWT) schedule. The TWT request/response may use the TWT Channel field to indicate the secondary channel requested to include the RU allocations addressed to the HE SST non-AP STA that is a X MHz operating STA. During the SP, the non-AP STA shall be available in the subchannel indicated in the TWT Channel field of the TWT response at TWT start times and does not access the medium in the subchannel using DCF or EDCAF, i.e., it can only be triggered by the AP. An HE SST non-AP STA may include a Channel Switch Timing element in (Re-) Association Request frames it transmits to an HE SST AP to indicate the time required by the STA to switch between different subchannels. The received channel switch time informs the HE SST AP of the duration of time that the HE SST non-AP STA might not be available to receive frames before the TWT start time and after the end of the trigger enabled TWT SP.

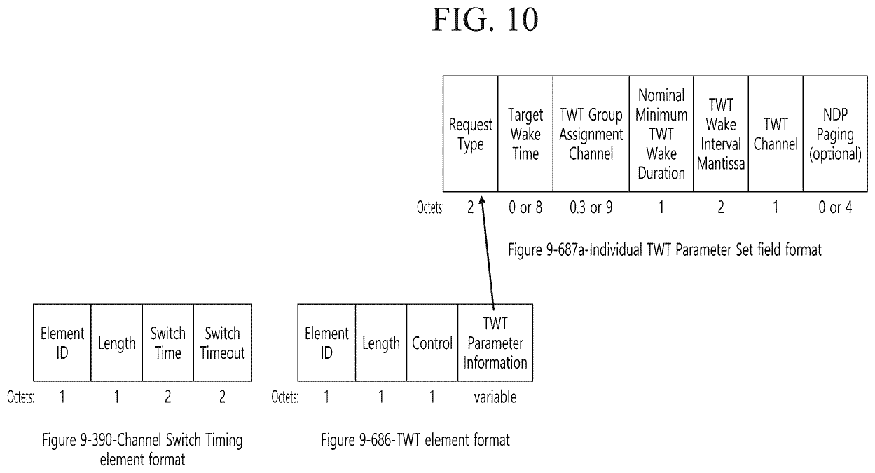

FIG. 10 illustrates different elements and fields used for SST negotiation in accordance with an embodiment. In particular, FIG. 10 illustrates a Channel Switch Timing element format that includes an Element ID, a Length field, a Switch Time field, and a Switch Timeout field. The Element ID provides an identifier for the element. The Length field provides length information for the element. The Switch Time field provides a switch timing information for the element. The Switch Timeout field provides switch timeout information for the element. FIG. 10 also illustrates a TWT element format that includes an Element ID field, a Length field, a Control field, and a TWT Parameter Information field. The TWT Parameter information field may include a Request Type field, a Target Wake Time field, a TWT Group Assignment field, a Nominal Minimum TWT Wake Duration field, a TWT Wake Interval Mantissa field, a TWT Channel field, and a NDP Paging field.

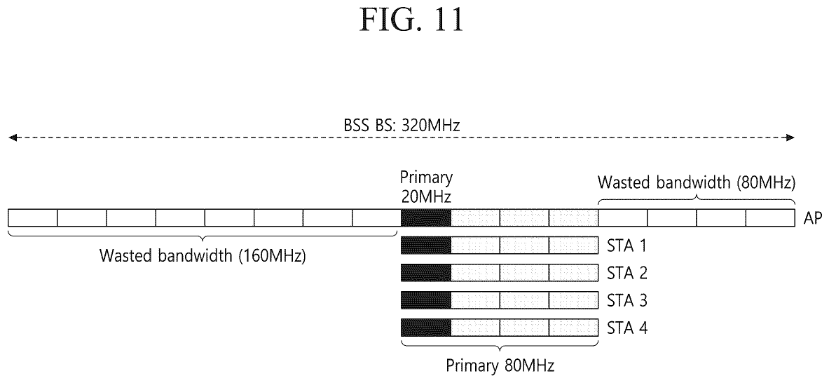

The IEEE 802.11be standard supports multiple bands of operation, where an access point (AP) and a non-AP device can communicate with each other, called links. Thus, both the AP and non-AP device may be capable of communicating on different bands/links, which is referred to as multi-link operation (MLO). Devices capable of MLO operation are referred to as multi-link devices (MLDs). As the maximum supported bandwidth for WiFi systems keeps rising, the AP bandwidth may become much wider than the current operating bandwidth each STA operates on, e.g., 320 MHz for AP and 80 MHz for STA. Note that even if a non-AP may support 320 MHz BW, it may reduce it to 80 MHz using Operating Mode change procedures. A non-AP STA may choose a smaller operating bandwidth due to multiple factors, including cost and power consumption considerations, and limited gains in throughput due to OBSS interference, among others. As per the standards, an 80 MHz STA can only be served on the 80 MHz primary channel of the BSS. So, if all STAs are 80 MHz then the additional 240 MHz bandwidth of a 320 MHz AP is wasted, as illustrated in FIG. 11.

FIG. 11 illustrates an example of wasted BSS bandwidth when all associated STAs only support a narrow bandwidth in accordance with an embodiment. In particular, the BSS BS supports 320 MHz bandwidth, however, each of STA1, STA2, STA3, STA4, and STA5 use only the same 80 MHz bandwidth. As indicated, the primary channel is 20 MHz, and each box represents 20 MHz of bandwidth. Accordingly, there are a remaining 160 MHz of wasted bandwidth and 80 MHz of wasted bandwidth outside of the utilized 80 MHz of bandwidth. A mechanism to resolve this issue may include where a non-AP MLD can perform Dynamic Sub-band Operation (DSO), wherein it can switch to a new subchannel that is outside of its initial operating bandwidth upon receiving a request from an AP.

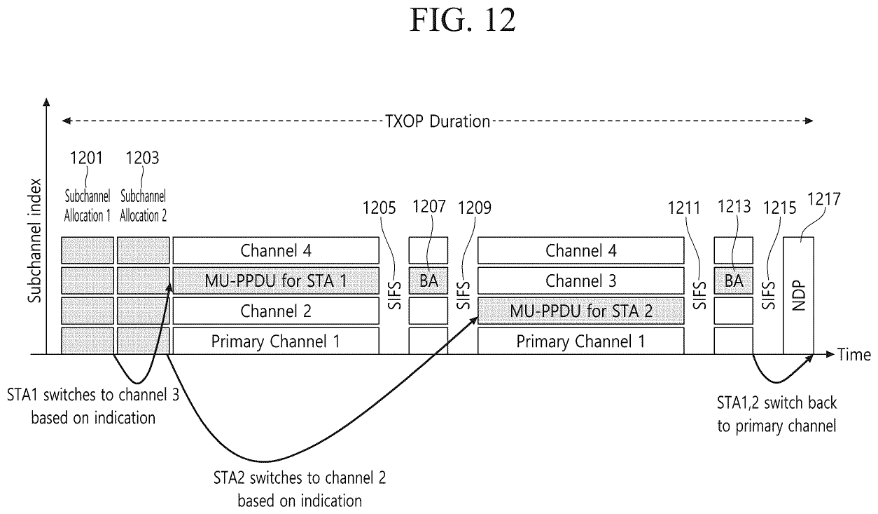

Embodiments in accordance with this disclosure may provide for setting up the Dynamic Sub-band Operation. In some embodiments, an AP, upon winning the channel access, may provide a scheduled indication of the DSO STAs it intends to serve, with the transmission start time and the subchannels on which it intends to serve them within the transmit opportunity (TXOP) or service period (SP). Here the allocated subchannels can be outside the primary channel monitored by the STA, and the indicated STAs may switch to the indicated subchannel for the remaining duration of the TXOP or SP to receive frames from the AP. Between the schedule indication and the actual transmission time, the AP can transmit frames to other STAs, or may provide schedule indication for the STAs that have a later transmission start time. If none exist, the AP may use post-FCS (frame check sequence) padding, packet extension and/or may transmit a separate null data packet (NDP) frame to keep the channel reserved. To prevent loss of medium synchronization for the STAs switching back to primary channel, at the end of the TXOP, the AP may transmit a frame, such as a PPDU, to non-DSO STAs, a QoS Null frame, and/or an NDP frame with appropriate padding. These mechanisms are illustrated in FIG. 12 in accordance with an embodiment.

FIG. 12 illustrates an STA 1 and STA 2 performing subchannel switch within a TXOP based on pre-allocation from the AP in accordance with an embodiment. For convenience, a configuration may be assumed of a BSS with an AP and one or more associated STAs. Here, the AP may support a wider maximum BSS bandwidth than some of the associated STAs. The AP and some of the STAs may support Dynamic Subchannel Operation (DSO). In DSO, upon winning channel access, in the beginning of a TXOP the AP can provide an indication to the DSO STAs the subchannels on which it intends to serve them within the TXOP or SP. Here the subchannel can be, for example, either a 20 MHz channel or a resource unit (RU) that is a part of the frequency on which the channel access has been won and which can even be outside of the primary channel, illustrated as the bottom-most subchannel in the figure, the STA monitors. These subchannels can also be referred to as sub-bands in certain embodiments. Upon receiving the indication, the indicated STAs may switch to the indicated subchannel for the remaining duration of the TXOP or SP to receive frames from the AP. This mechanism can help efficiently utilize the full BSS bandwidth of the AP, when the associated STAs support a smaller bandwidth. As illustrated in FIG. 12, an AP may transmit a frame that includes a subchannel allocation, illustrated as subchannel allocation 1 frame (1201) that indicates that STA1 is allocated to channel 3, and subchannel allocation 2 frame (1203) that indicates that STA2 is allocated to channel 2. Accordingly, STA1 switches to channel 3 based on the frame indication and can receive MU-PPDUs on channel 3. After a first SIFS 1205, STA1 may transmit a block acknowledgement (BA) 1207 on channel 3. After a second SIFS 1209, STA2 switches to channel 2 based on the frame indication and can receive MU-PPDUs on channel 2. After a third SIFS 1211, STA 2 may transmit a block acknowledgement 1213 and may switch back to the primary channel. After a fourth SIFS 1215, the AP may transmit an NDP frame 1217.

In some embodiments, between the schedule indication and the actual transmission time, the AP can transmit frames to other STAs, or may provide schedule indication for the STAs that have a later transmission start time. If none exist, the AP may use post-FCS padding, packet extension or may transmit a separate NDP frame to keep the channel reserved. To prevent loss of medium synchronization for the DSO STAs switching back to primary channel, at the end of the TXOP, the AP may transmit a frame, such as a PPDU to the STAs or a QoS Null frame or an NDP frame with appropriate padding.

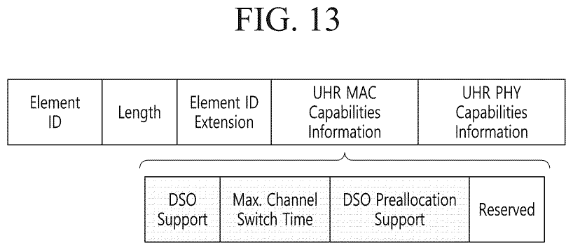

In some embodiments, it may be mandatory for an Ultra High Reliability (UHR) AP MLD to be able to support a non-AP STA operating in Dynamic Subchannel Operation (DSO) mode. In certain embodiments, the AP MLD may indicate if it supports an associated non-AP STA operating in DSO mode, by setting a capability bit to 1 in the UHR Capabilities element that it transmits in Beacon and Probe Response frames. Otherwise. the bit may be set to 0. The bit can be called, for example, the DSO Support subfield as illustrated in FIG. 13 in accordance with an embodiment.

FIG. 13 illustrates a DSO Capability element indication by a STA/MLD in accordance with an embodiment. The element may include an Element ID field, a Length field, an Element ID Extension field, a UHR MAC Capabilities field, a UHR PHY Capabilities Information field. The Element ID may provide an identifier of the element. The Length field may provide length information of the element. The Element ID Extension field may provide extension information of the element. The UHR MAC Capabilities Information field may provide capabilities information of the element and can include several subfields as described below. The UHR PHY Capabilities Information field may provide PHY capabilities information of the element. The UHR MAC Capabilities Information field can include a DSO Support field, a Max. Channel Switch Time field, a DSO Reallocation field, and a Reserved field. The DSO Support field may provide information regarding whether DSO is supported. The Max. Channel Switch Time field may provide information regarding a maximum channel switch time that the AP is willing to accommodate for any STA intending to operation in DSO mode. In some embodiments, the AP may also indicate in its UHR Capabilities the maximum Channel Switch Time it is willing to accommodate for any STA intending to operate in DSO mode. In certain embodiments, the Max allowed Channel Switch Time for DSO may be predetermined by the standard, and so this field may not be present. In certain embodiments, there can also be a separate DSO Preallocation Support field that indicates if an AP supports DSO sub-band pre-allocation, where pre-allocation refers to allocating the sub-band to a STA that can be served at a later time within the TXOP. The Reserved field may be reserved.

In some embodiments, it may be mandatory for an UHR non-AP MLD to be able to support operating in DSO mode. In some embodiments, the non-AP MLD can indicate if all its STAs support operating in the DSO mode, by setting a capability bit to 1 in the UHR Capabilities element that it transmits in probe request and association response frames. Otherwise, the bit may be set to 0. The bit can be called, for example, DSO Support subfield. In certain embodiments, the capability to support DSO may differ for each STA of an MLD, and so the capability bit can be distinct for each STA. This can either be indicated by using a DSO Support Bitmap, or by including the DSO Support bit in the Per STA Profile of the Basic Multi-link element transmitted by the MLD. In certain embodiments, a non-AP STA may also indicate the Channel Switch Time for its DSO operation within the UHR Capabilities element. In certain embodiments, there can also be a separate DSO Preallocation Support field that indicates if an DSO STA supports DSO sub-band pre-allocation, where pre-allocation refers to allocating the sub-band to a STA that can be served at a later time within the TXOP. It may be mandatory for a DSO STA to support DSO Preallocation if the Max. Channel Switch Time is above a certain threshold, e.g. 128 μs.

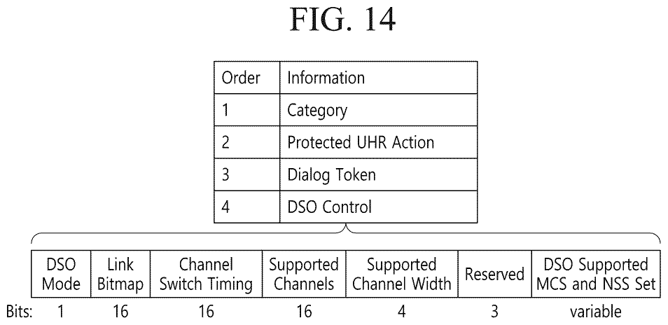

FIG. 14 illustrates a DSO Mode Notification frame in accordance with an embodiment. The fame may include a DSO Mode field, a Link Bitmap field, a Channel Switch Timing field, a Supported Channels field, a Supported Channel Width field, a Reserved field, and a DSO MCS and NSS Set field. In some embodiments, a non-AP STA that supports DSO and is associated with an AP that supports DSO may always be operating with DSO capability. In certain embodiments, the DSO operation may be a mode that the non-AP STA explicitly enables by sending a notification frame to the AP it is associated with. In some embodiments, this mode switch may be performed independently for each link. In some embodiments, the mode switch may be performed jointly for one or more links. In the notification frame sent by a UHR non-AP STA to initiate a switch into DSO mode it may also include one or more indications including the following indications.

The DSO Mode field may provide an indication of whether the transmitting STA is switching into or out of the DSO mode. In one example, this can be indicated with a 1-bit DSO mode field.

The Link Bitmap may provide an indication of the links of the non-AP STAs affiliated with the non-AP MLD for which the DSO Mode switch is applicable. In some embodiments, this can be indicated with a 16-bit Link ID Bitmap field. In certain embodiments, it can be indicated using a 4-bit Link ID field.

The Channel Switch Timing filed may provide an indication of the time that STAs of the non-AP STA/MLD need to perform the channel switch upon receiving an allocation. In some embodiments, this can be a 2-octet field that indicates the time in units of microseconds. In certain embodiments, this indication can be carried in the Channel Switch Timing field of a Channel Switch Timing element.

The Supported Channels field may provide an indication of the supported sub-channels to which the non-AP STA/MLD is capable of switching to. In some embodiments, this can be indicated in a 16-bit channel bitmap, where each bit corresponds to a 20 MHz channel starting from the lowest such 20 MHz channel within the maximum BSS bandwidth. In certain embodiments, this can be indicated in a Supported Channels element. An indication of the bandwidth of the transmission that the non-AP STA/MLD can support. In some embodiments, this can be indicated using a 4-bit field, with an indication of n if the STA/MLD supports a maximum bandwidth of 20×22 MHz in DSO Mode. In certain embodiments, this can be indicated in the Supported Channel Width Set field and Extended NSS BW Support field.

The DSO Supported and MCS and NSS Set field may provide an indication of the MCS-NSS set that the non-AP MLD/STA can support after the switch. In some embodiments, this can be indicated in the Supported UHR-MCS and NSS Set field.

Some embodiments may provide an indication of the maximum number of sub-channels the non-AP STA may be willing to switch to. In this case, the AP may determine the appropriate sub-channels for the non-AP STA and indicate the same to it in the response frame. Some embodiments may provide an indication of whether the DSO STA will support DSO pre-allocation while operating in DSO mode. This may refer to supporting a time gap between the reception of sub-band allocation and the actual data transmission within the same TXOP. The time gap can be used, for example, by the AP to serve other STAs.

In some embodiments, one or more of the above indications can be indicated during the association phase with the AP or can be included in the PHY or MAC Capabilities elements transmitted by a non-AP STA (instead of being part of the Notification frame). In some embodiments, the notification frame can be called DSO Mode Notification frame, as illustrated in FIG. 14 in accordance with an embodiment.

In some embodiments, the DSO Mode Notification frame can be a variant of the Operating Mode Notification frame or Enhanced Operating Mode Notification frame. In some embodiments, the AP, upon receiving the Notification frame from a non-AP MLD/STA, may send a response Notification frame to confirm the mode switch. In the response frame an AP may reject a switch to DSO mode, for example if the Channel Switch Time indicated by the STA is too long. Correspondingly the response frame may have a Reason Code to indicate a reason for the rejection and an alternative set of suggested parameters to be used for DSO mode. In this case, the setup of DSO mode can be a negotiation process between a non-AP STA and the AP, wherein the non-AP can retransmit a new DSO Notification frame with updated parameters based on the indications/suggestions received from the AP in the previous unsuccessful response frame. In some embodiments, a STA of a non-AP MLD operating in EMLSR mode, and which is operating on an EMLSR link may not be allowed to operate in DSO mode. In certain embodiments, an EMLSR device may be allowed to operate in DSO mode.

In some embodiments, upon winning the channel access for a TXOP or a service period (SP), the AP may transmit a CTS-to-Self frame in a duplicate PPDU format to protect all 20 MHz sub-channels where it has won the channel access. The CTS-to-self frame is a CTS frame in which the RA field is equal to the transmitter's MAC address. In some embodiments, within the won TXOP, the AP may transmit a frame to indicate the STA(s) with which it intends to perform frame exchanges on the non-primary channels within the TXOP. The frame may include an indication of one or more of the following fields.

In some embodiments, the frame may include the AIDs of the non-AP STAs it intends to serve (for either downlink or triggered uplink traffic). In some embodiments, only the AIDs of UHR STAs may be indicated within the frame. In certain embodiments, only AIDs of STAs that support DSO operation may be included within the frame. In certain embodiments, AIDs of legacy STAs may also be included within the frame.

In some embodiments, the frame may include the start time of transmission of data PPDUs or trigger frames to the STAs. In one example, the time can be indicated in units of microseconds or TUs, counting from the transmission time of the frame. In another example, rather than a time indication there can be a Preallocation field that can be set to ‘0’ or ‘l’ to indicate whether the AP intends to perform frame exchanges with the indicated STAs immediately or later within the TXOP, respectively.

In some embodiments, the frame may include the indication of whether an addressed non-AP STA is expected to send a response frame. In one example, the AP may not solicit a response from a subset of the non-AP STAs intended to be served later within the TXOP.

In some embodiments, the frame may include the allocation of RUs where an addressed non-AP STA is expected to send the response if it is solicited. In one example, this field can have 8 bits, and can have an encoding similar to the RU Allocation subfield of the MU-RTS Trigger frame or the User Specific field of a HE MU PPDU. The frame may include the allocation of RUs or sub-channels where it intends to serve the non-AP STAs. This RU/sub-channel allocation may be a superset of the final RU allocation made to the STA. If the STA supports DSO mode, the RU/sub-channel allocation can also be outside of the STA's current operating channel. Otherwise, the RU/sub-channel allocation can be inside of the STA's current operating channel. In some embodiments, the RU/sub-channel allocation may be within the bandwidth of the TXOP. In certain embodiments, this can be indicated using an 8-bit Target Channel field that indicates the channel number, and optionally a Secondary Channel Offset element and a Wide Bandwidth Channel Switch element. In certain embodiments, this field can have 8 bits, and can have an encoding similar to the RU Allocation subfield of the MU-RTS Trigger frame or the User Specific field of a HE MU PPDU. In some embodiments, this field can be a bitmap of 8 bits, each bit of the bitmap corresponding to one minimum width channel for the band on which the BSS is operating. This can be, for example, 20 MHz. The bit n of the bitmap may correspond to the minimum width channel with the n-th lowest center frequency. The encoding can be similar to the TWT Channel field that is used for SST operation.

In some embodiments, there may be a unique pre-determined mapping between the RU allocation for sending the response, and the sub-channels where the AP intends to serve the non-AP STA. In such a case, separate indications of the allocation of sub-channels may not be required. For example, an X MHz DSO STA is expected to monitor the X MHz channel that overlaps with the RU Allocation assigned to the STA for sending the response frame. In some embodiments, the frame may include the allocation of the temporary primary 20 MHz channel for performing the preamble detection for each STA.

In some embodiments, the frame may include the Switch Back Time after which the STAs are expected to return to the base primary channel. In some embodiments, the time can be indicated in units of microseconds or TUs, counting from the transmission time of the frame. In certain embodiments, this switch-back time can be same as the TXOP end time, as indicated by the NAV setting. In certain embodiments, this time can be set to be a little earlier than the NAV end time reserved by the AP's TXOP, to ensure that the STAs returning to the primary channel do not lose medium synchronization after switching back.

In some embodiments, the frame may be transmitted in a non-HT duplicate PPDU format on all the 20 MHz channels of the TXOP. In certain embodiments where the TXOP is reserved using a CTS-to-self, the frame may be transmitted in a non-duplicate PPDU format and at a higher data rate. In some embodiments, the frame may be transmitted with a broadcast receive address. In some embodiments, the AP may ensure that the allocated RUs or subchannels to a DSO STA comply with the Supported Channels indicated by the STA. The AP may also take into consideration the minimum frequency separation required for simultaneous transmit and receive (STR) operation indicated by a non-AP MLD when performing the subchannel assignment to a STA of the non-AP MLD. In some embodiments, the AP may ensure that the start time of transmission complies with the Channel Switch Timing required by each of the STAs which are notified to switch their channels, and which are expected to be served first within the TXOP. This frame may be called, for example, a Subchannel Allocation frame, Sub-band Allocation frame, Sub-band Switch Initial Control frame, etc.

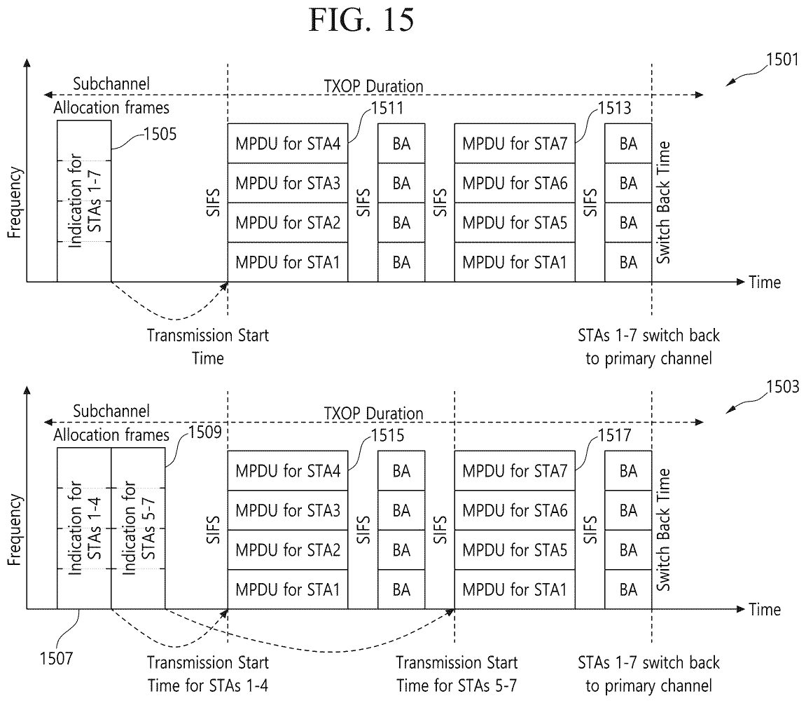

FIG. 15 illustrates two different mechanisms for sub-channel allocation for STAs that are served within the TXOP in accordance with an embodiment. In some embodiments, the subchannel allocation for all the UHR or DSO STAs which are served in the TXOP are indicated in a single frame, as exemplified in example 1501 of FIG. 15. In certain embodiments, there can be multiple follow up subchannel allocation frames, each corresponding to a later transmission start time, as exemplified in example 1503 of FIG. 15. A STA's AID can be included in multiple such frames, to indicate a different sub-channel allocation for that STA at different transmission start times. At or after the indicated start time, the AP may transmit either: an MU-RTS frame to obtain CTS from the STAs, with RU allocation being a subset of the allocated sub-channels in the Subchannel Allocation frame, or an MU-PPDUs to the STAs, with RU allocation being a subset of the allocated sub-channels in the Subchannel Allocation frame, or a trigger frame to solicit trigger-based uplink frames from the STAs with RU allocation being a subset of the allocated sub-channels in the Subchannel Allocation frame. These transmissions can be sent in a separate PPDU, initiated with their own PHY header to enable channel equalization. As illustrated in example 1501, the subchannel allocation frame 1505 provides an indication for STAs 1-7, with a particular transmission start time. Accordingly, STA1, STA2, STA3, and STA4 receive MPDUs 1511 on the particular subchannel starting at the transmission start time, and STA7, STA6, STA5, and STA1 receive a subsequent MDPDU 1513 on the particular subchannels, after which the STAs 1-7 switch back to the primary channel. Furthermore, various SIFS and BAs are transmitted as illustrated between the MPDUs.

In the example 1503 of FIG. 15, a first subchannel allocation frame 1507 provides indications for STAs 1-4 and a subsequent subchannel allocation frame 1509 provides indications for STAs 5-7. At the transmission start time for STAs1-4, the MPDUs 1515 are received by these STAs 1-4 on the corresponding subchannels. At the transmission start time for STAs 5-7, the MPDUs 1517 are received by these STAs 5-7 on their corresponding subchannels, and the STAs1-7 switch back to the primary channel. Various SIFS and BA are exchanged as illustrated before, in between and after the MPDUs.

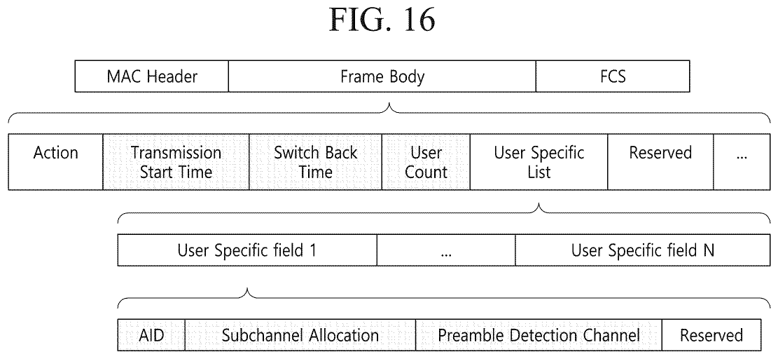

In some embodiments, the frame may be an Action No Ack frame called ‘Subchannel Allocation’ frame, as illustrated in FIG. 16 in accordance with an embodiment. In particular, FIG. 16 illustrates an example of the subchannel allocation using a new Action No Ack frame in accordance with an embodiment. The frame may include a MAC Header field, a Frame Body field, and an FCS field. The Frame Body field may include an Action field, a Transmission Start Time field, a Switch Back Time field, a User Count field, a User Specific List field, a Reserved field, among others. The User Specific List field may include User Specific fields 1 to N. A User Specific Field may include an AID field, a Subchannel Allocation field, a Preamble Detection Channel field and a Reserved field.

The MAC Header field may provide a MAC information of the frame. The Frame body may include various subfields. The FCS field may be a frame check sequence filed for error detection.

The Action field of the Frame body may identify the subtype of the Action No Ack frame. The Transmission Start Time field, Switch Back Time fields of Frame body may have a format as defined herein. In particular, the Transmission Start Time field may provide timing information for a start of a transmission. The Switch Back Time field may provide timing information for switching back to a primary channel. The User Count field may provide a user count information. The Reserved field may be reserved.

The User Specific List of the Frame body may have N User Specific fields, where N-1 is the number indicated in the User Count field. Each User Specific field may have: an AID subfield to identify the AID of the STA it addresses, a Subchannel Allocation subfield to indicate the Sub-channel allocated to the STA, a Preamble Detection Channel field to indicate the channel where the STA should perform the preamble detection. In certain embodiments, the Transmission Start Time and/or Switch Back Time may be indicated inside the User Specific field for each AID.

In some embodiments, the frame can be a new type of Trigger frame (TF) called “Delayed ACK” Trigger frame, where the ACK can be sent by the recipient at a delayed time that is indicated within the Trigger frame.

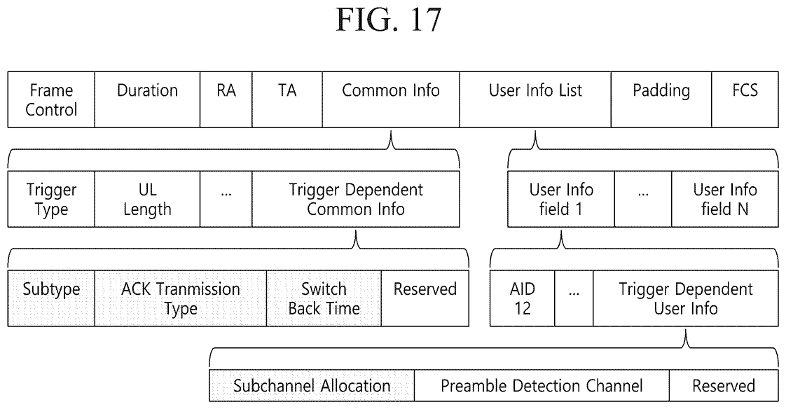

FIG. 17 illustrates an example of the subchannel allocation using a Delayed ACK Trigger frame in accordance with an embodiment. The frame may include a Frame Control field, a Duration field, an RA field, a TA field, a Common Info field, a User Info List field, a Padding field, and an FCS field. The Common Info field may include a Trigger Type field, a UL Length field, and a Trigger Dependent Common Info field, among other fields. The User Info List field may include User Info fields 1 to N. The Trigger Dependent Common Info field may include a Subtype field, an ACK Transmission Time field, a Switch Back Time field, and a Reserved field, The User Info field may include AID field and Trigger Dependent User Info field among others. The Trigger Dependent User Info field may include a Sub-channel Allocation field, a Preamble Detection Channel field and a Reserved field.

In particular, the Trigger Type subfield of the Common Info field of the trigger frame may identify the “Delayed ACK” TF. The Trigger Dependent Common Info subfield of the Common Info field may have: a Subtype field that indicates that the TF is for ‘Subchannel Allocation’, a field that indicates the time for transmission of the ACK by the STAs indicated in the User Info List. This can be in units of microseconds, a field that indicates the time of Switch Back Time when the STAs need to return to base primary channel.

The Trigger Dependent User Info field of the User Info field may have: a Sub-channel Allocation field to indicate the sub-channel allocated to the STAs. In some embodiments, the RU Allocation field of User Info field may serve this role, a Preamble Detection Channel field to indicate the channel where the STA should perform the preamble detection.

As illustrated in FIG. 17, the Frame Control field may provide control information. The Duration field may provide duration information. The RA field may provide a receiver address. The TA field may provide a transmitter address. The Common Info field may include various subfields as described. The User Info List may include various subfields as described. The Padding field may provide padding information. The FCS (frame control sequence) field may provide error detection information.

The Trigger Type field may provide type information. The UL Length field may provide length information. The Trigger Dependent Common Info field may include a Subtype field that provides subtype information, an ACK Transmission Time field that provides a transmission time acknowledgment, a Switch Back Time field that provides a switch back timing information and a Reserved field that may be reserved.

The AID field may provide an identifier information of the STA. The Trigger Dependent User Info field may include a Sub-channel Allocation field that provides a sub-channel allocation information, a Preamble Detection Channel field that provides preamble detection channel information, and a Reserved field that is reserved.

In some embodiments, the frame can be a new type of Trigger frame (TF) called “No ACK” Trigger frame, where no ACK needs to be sent by the recipient STA.

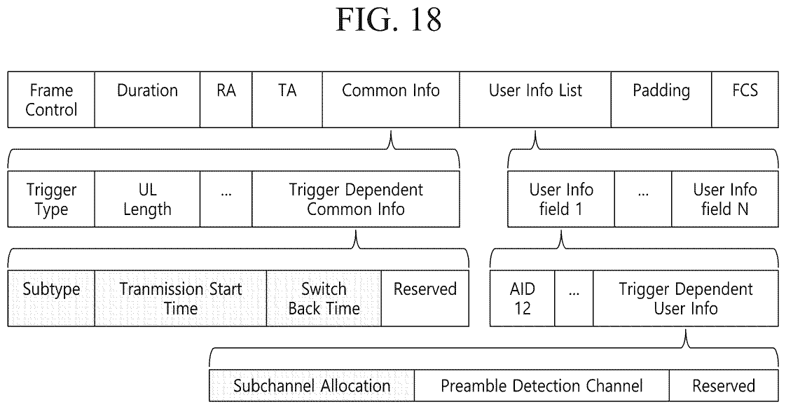

FIG. 18 illustrates an example of the subchannel allocation using a No ACK Trigger frame in accordance with an embodiment. The frame may include fields similar to those described with respect to FIG. 17. However, a difference with FIG. 17 is that the Trigger Dependent Common Info field may include a Subtype field, a Transmission Start Time field, a Switch Back Time field, and a Reserved field. The Trigger Type subfield of the Common Info field of the trigger frame may identify the “No ACK” TF. The Trigger Dependent Common Info subfield of the Common Info field may have one or more of the following fields. A Subtype field that indicates that the TF is for ‘Subchannel Allocation’. A Transmission Start Time filed field that indicates the start time for transmission of frames to the STAs indicated in the User Info List. This can be in units of microseconds. A Switch Back Time field that indicates the switch back time, when the STAs need to return to base primary channel.

The Trigger Dependent User Info field of the User Info field may have one or more of the following fields. A Sub-channel Allocation field to indicate the sub-channel allocated to the STAs. In certain embodiments, the RU Allocation field of User Info field may serve this role. A Preamble Detection Channel field to indicate the channel where the STA should perform the preamble detection.

In some embodiments, the frame can be the MU-RTS trigger frame. Devices prior to the IEEE 802.11bn standard may also be addressed using such a MU-RTS frame. In some embodiments, the Common Info field can have one or more of the following fields. A “Sub-type” field to indicate that the MU-RTS frame is a subchannel allocation frame. Such a field can have 1-4 bits, and a specific bit sequence may indicate the fact that the MU-RTS includes some DSO specific User Info fields. In this case the sub-channel allocation frame may solicit an immediate response a SIFS duration after the end of the frame and hence the ACK Transmission Time indication may not be present. However, the ACK response may not be solicited from all the addressed STAs. The User Info list of the MU-RTS frame can have several User Info fields, and some of them may be DSO-specific User Info fields. DSO-specific User Info fields may be addressed to DSO STAs for which the AP intends to perform sub-channel allocation. The reserved fields of the User Info field in a conventional MU-RTS frame may be used for indicating DSO parameters in the DSO-specific User Info field. These DSO specific parameters may include one or more of the following fields. A Sub-channel Allocation field to indicate the sub-channel allocated to the STAs. In certain embodiments, the RU Allocation field of User Info field may serve this role. In certain embodiments, the RU Allocation field may indicate the RU to send the CTS response, and there may be a predetermined mapping from the RU Allocation to the Sub-channel allocation, thus avoiding need for a separate field. A Preamble Detection Channel field to indicate the 20 MHz subchannel where the STA should perform the preamble detection for the duration of the TXOP. A Scheduling Time field (or Preallocation field) that can be set to ‘0’ or ‘1’ to indicate that the AP intends to perform frame exchanges with the indicated STAs immediately or later within the TXOP. A Response Solicited field to indicate whether a response to the trigger frame is solicited from the STA. In one example, the AP may not solicit a response from a subset of the non-AP STAs intended to be served later within the TXOP.

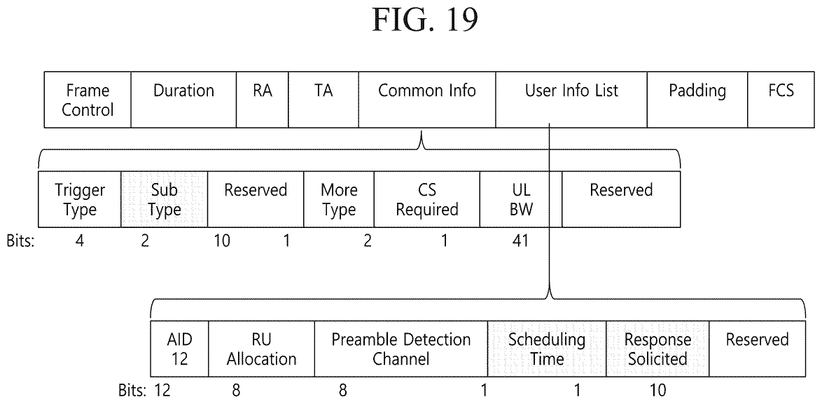

FIG. 19 illustrates an example illustration of this field in the Common Info field in accordance with an embodiment. In some embodiments, the STAs with which the AP intends to perform frame exchanges later within the TXOP may not respond to the MU-RTS frame. In certain embodiments, the STAs with which the AP intends to perform frame exchanges later within the TXOP may respond to the MU-RTS on the primary 20 MHz channel and perform the subchannel switch after responding.

FIG. 19 illustrates an MU-RTS frame as a subchannel allocation frame in accordance with an embodiment. The frame may include a Frame Control field, a Duration field, an RA field, a TA field, a Common Info field, a User Info List field, a Padding field, and an FCS field. The Common Info field may include a Trigger Type field, a Sub Type field, a Reserved field, a More TF field, a CS Required field, a UL BW field, and a Reserved field. The User Info List may include an AID field, a RU Allocation field, a Preamble Detection Channel field, a Scheduling Time field, a Response Solicited field, and a Reserved field.

The Frame Control field may provide control information. The Duration field may provide duration information. The RA field may provide a receiver address. The TA field may provide a transmitter address. The Common Info field may include various subfields. The User Info List may include various subfields. The Padding field may provide padding information. The FCS (frame control sequence) field may provide error detection information.

The Trigger Type field may provide type information. The Sub Type field may provide sub type information. The Reserved field may be reserved. The More TF field may provide more trigger frame information. The CS Required field may provide CS information. The UL BW field may provide UL BW information. The AID field may provide identifier information. The RU Allocation field may provide RU Allocation information. The Preamble Detect Channel field may provide preamble detect channel information. The Scheduling Time field may provide scheduling timing information. The Response Solicited field may provide response solicited information.

In some embodiments, other types of trigger frames such as the Block Ack Request (BAR) frame, the Buffer Status Report Poll (BSRP) trigger frame, or the Bandwidth Query Report Poll (BQRP) trigger frame, among others, may be used as the subchannel allocation frame with similar fields as in the Common Info and User Info fields to provide the DSO specific parameters.

In some embodiments, the AP may ensure that the Transmission Start Time in the subchannel allocation frame complies with the Channel Switch Timing required by each of the STAs which are notified to switch their channels. In particular, the Transmission Start Time can be set to at least a time T after the end of the transmission of the subchannel allocation frame, where T may be equal to the maximum of the Channel Switch Times among to the STAs requested to switch channel within the subchannel allocation frame. In some embodiments, the AP may ensure that the Transmission Start Time in the subchannel allocation frame complies with the Channel Switch Timing required by each of the STAs which are notified to switch their channels, and which are expected to be served first. In this case, T may be equal to the maximum of the Channel Switch Times among the STAs requested to switch channel within the subchannel allocation frame and which are expected to be served first by the AP.

In order to protect the wireless medium while the STAs perform the channel switch, the AP may transmit some signal on the wireless medium on all the bands of the TXOP for sufficient time T after transmitting the subchannel allocation frame. In some embodiments, the signals protecting the channel switch time T after the transmission of the subchannel allocation frame can include a one or more of the following transmissions. Transmission of the subsequent subchannel allocation frames that provide allocations to STAs to be served later in the TXOP with any appropriate required padding to extend to the time duration T.

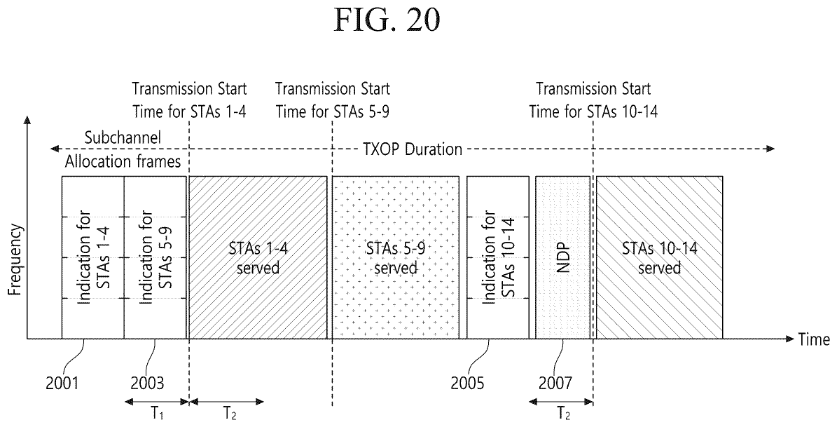

FIG. 20 illustrates using subchannel allocation frames or data frames for other STAs or NDP frames to protect the channel switch time required by STAs in accordance with an embodiment. In particular, the AP transmits a subchannel allocation frame 2001 with indications for STAs 1-4 with a transmission start time, and a subsequent subchannel allocation frame 2003 with indication for STAs 5-9. Starting at the transmission start time for STAs 1-4, the STA1-4 are served. Starting at the transmission start time for STA 5-9, these STAs 5-9 are served. The AP transmits a frame 2005 with indication for STAs 10-14, and subsequently transmits NPDs 2007 until the transmission start time for STAs 10-14. Accordingly, at the transmission start time for STAs 10-14, these STAs are served. In particular, the AP may transmit a QoS Null frame or a Null Data Packet (NDP) frame, among others, with any appropriate required padding to extend to the time duration T. This is exemplified for the resource allocation frame for STAs 10-14 in FIG. 20. Some embodiments may transmit a newly defined Padding element or a padding frame, whose purpose is to just provide a required padding delay on a link.

In some embodiments, the use of subchannel allocation frames for later STAs or the transmission of frames for other STAs may be preferred method to occupy time T, and if no STAs exist, then the AP may use other mechanisms like use of QoS Null frame, among others. In some embodiments, rather than relying on a separate follow-up frame, the required signals to occupy the channel for duration T can be provided within the first subchannel allocation frame. In some embodiments, this can be performed by using a Padding field that precedes the frame check sequence (FCS) in the subchannel allocation frame. In certain embodiments, to enable successful reception of the frame and perform FCS check, a padding can be provided after the FCS field of the subchannel allocation frame, using, for example, the packet extension field. New values of packet extension that can have a duration up to 128 μs can be defined for this. In some embodiments, a new Padding element may be defined that can be included in the frame after the FCS field.

In some embodiments, the AP may end data transmissions to the DSO STAs before the end of the TXOP to enable all the DSO STAs to perform a channel switch back to the primary channel without loss of medium synchronization. The time required T may be be equal to the largest of the Channel Switch Times among all the STAs that are expected to perform the channel switch back to the primary channel at the end of the TXOP. In some embodiments, for this time T after end of the data transmissions to DSO STAs, the AP may be required to transmit a signal on all the channels of the TXOP. In certain embodiments, for this time T after end of the data transmissions to DSO STAs, the AP may be required to transmit a signal only on the primary 20 MHz channel. The signal transmission can be, for example, data sent to STAs that do not require to perform channel switch or can be a frame such as a QoS Null frame with required padding. In some embodiments, the AP explicitly indicates the Channel Switch Back time for each STA that can be shorter than the TXOP end time. In certain embodiments, the AP may use the EOSP=1 or More Data=0 of a downlink PPDU to a STA to indicate that the STA may switch back to the primary channel. In some embodiments, the Channel Switch Back time may be implicitly determined by the STA based on the TXOP end time.

In some embodiments, if one or more STAs required to perform subchannel switch within TXOP are operating in Enhanced Multilink Single-Radio (EMLSR) mode, the Subchannel Allocation frame can be transmitted by the AP in a non-HT duplicate PPDU with a data rate of 6, 12 or 24 Mbps. This frame can be added to the list of initial control frames used for EMLSR operation. If one or more STAs addressed within the Subchannel Allocation frame are EMLSR STAs, the transmission start time or required padding T may be determined by the larger of the EMLSR Padding Delay and Channel Switch Time among all the STAs that are served first within the TXOP. Note however that if an EMLSR STA that is operating in DSO mode is allocated RUs within its operating bandwidth during receive operation (as indicated in the PHY capabilities element), then the EMLSR Padding Delay may be considered but the Channel Switch Time for the STA may not be considered in determining the transmission start time and/or required padding. In some embodiments, the AP may exclude EMLSR STAs from the Subchannel Allocation frame. The AP may separately transmit an EMLSR initial control frame to enable all the required EMLSR devices served within the TXOP to perform channel switch to their allocated channel. This initial control frame can be sent either before or after the Subchannel Allocation frame. The RU allocation in the EMLSR initial control frame may indicate if the EMLSR device is required to perform a channel switch to a non-primary channel. The padding in the initial control frame can be the larger of the EMLSR Padding Delay among all the addressed EMLSR STAs and the Channel Switch Time among all the addressed EMLSR STAs that require to perform channel switch.

In some embodiments, if one or more STAs addressed within the Subchannel Allocation frame are Enhanced Multi-Link Multi Radio (EMLMR) STAs, the transmission start time or required padding T may be determined by the larger of the EMLMR Padding Delay and Channel Switch Time among all the STAs that are served first within the TXOP. Note however that if an EMLMR STA that is operating in DSO mode is allocated RUs within its operating bandwidth during receive operation (as indicated in the PHY capabilities element), then the EMLMR Padding Delay may be considered but the Channel Switch Time for the STA may not be considered in determining the transmission start time and/or required padding. The Subchannel Allocation frame may be transmitted at the basic MCS and NSS supported by the EMLMR STA before performing the EMLMR radio switch.

In some embodiments, upon successfully receiving the subchannel allocation frame, a non-AP STA may immediately switch to the indicated sub-channel. In certain embodiments, the non-AP STA may ensure that it switches to the indicated sub-channel at or before the indicated transmission start time or the delayed ACK transmission time. If required, the non-AP STA may transmit an ACK or response frame at the indicated time. In some embodiments, if the non-AP STA is expected to send a response to the subchannel allocation frame and/or is expected to be served immediately, it can determine if the remaining duration of the allocation frame is sufficient for it to perform the switch. Here the duration of the frame can be determined from the Length subfield of the L-SIG field of the allocation frame, and the remaining duration can be counted from the time when the signaling of sub-band has been successfully received by the non-AP STA and any necessary frame checks are completed. The STA may not perform the switch or transmit the response frame if the remaining duration is insufficient for the STA to perform the switch.

In some embodiments, once a non-AP switches to a sub-channel, it may remain there till the end of the TXOP or till the Switch Back Time duration indicated by the AP. In certain embodiments, the non-AP STA may determine the appropriate Switch Back Time based on the indication of the end of TXOP time and its own Channel Switch Time. The non-AP STA may stay on the subchannel longer than this time if it is involved in an active frame exchange with the AP. In some embodiments, if the AP transmits a PPDU to a non-AP STA with an EOSP subfield set to 1, it may switch back immediately to the primary channel. In certain embodiments, if a non-AP STA that switches to an indicated sub-channel observed the channel to be IDLE for more than a threshold time, it may switch back immediately after that to the primary channel. In some embodiments, if a non-AP STA that switches to an indicated sub-channel observes a PPDU on that sub-channel that corresponds to another BSS or if neither the transmit address nor receive address of the PPDU correspond to the AP, it may immediately switch back to the primary channel. In certain embodiments, if a non-AP STA that switches to an indicated sub-channel is not served by the AP within a threshold time after the indicated transmission start time, it may switch back to the primary channel. In some embodiments, additional switch back rules may apply if the non-AP STA has not indicated support for pre-allocation. For example, if a non-AP STA does not support pre-allocation, it may switch back to the primary channel if the first frame exchange after the sub-band allocation is not addressed to it or the frame is not received correctly by it. In some embodiments, the non-AP may perform the switch back such that the switch can be completed before end of the NAV timer reserved by the APs TXOP. This can be to prevent loss of medium synchronization.

In some embodiments, the non-AP STA that switches to a non-primary sub-channel may not perform channel contention for the duration of time for which it remains on the sub-channel. In some embodiments where the AP does not indicate a 20 MHz channel for performing the preamble detection, the non-AP STA may perform preamble detection on any 20 MHz sub-channel of its allocated sub-channel. In certain embodiments, there may be a pre-determined unique mapping between the allocated subchannel and the temporary 20 MHz channel where the preamble detection should be performed. This may either be fixed by the spec, or the mapping may be indicated by the AP in management frames such as Beacon, Probe Response, or Association Response frames.

In some embodiments, if the non-AP STA is part of an MLD that is operating in both DSO mode and EMLSR mode, then the Subchannel Allocation frame may act like an initial control frame for EMLSR operation. In some embodiments, the AP may send a separate initial control frame to the non-AP STA to indicate its RU allocation which may be outside the primary channel. In some embodiments, an EMLSR non-AP STA operating in DSO mode may not support preallocation. The other rules for EMLSR operation, such as the switch back rules or being unavailable on the other EMLSR links of the non-AP MLD during the TXOP may still be applicable.

In some embodiments, if the non-AP STA is part of an MLD that is operating in both DSO mode and EMLMR mode, then Subchannel Allocation frame may act like an initial frame for EMLMR operation. In certain embodiments, the AP may send a separate initial frame to the non-AP STA to indicate its RU allocation which may be outside the primary channel. In some embodiments, an EMLSR non-AP STA operating in DSO mode may not support preallocation. The other rules for EMLMR operation, such as the switch back rules or being unavailable on the other EMLMR links of the non-AP MLD during the TXOP may still be applicable.

In some embodiments, if the AP decides to terminate the TXOP early, it may send a CF-End frame in a duplicate HT PPDU on all the subchannels so that all STAs can receive it. Upon receiving the TXOP termination indication the STAs may switch back to their base primary channel. In some embodiments, the AP may only transmit the CF-End frame on the non-primary channels and may transmit some other frame on the primary channel to keep the medium occupied while the DSO STAs perform the channel switch back. This can again be to prevent loss of medium synchronization for the DSO STAs. In certain embodiments, the CF-end may also be transmitted by a non-AP DSO STA involved in the frame exchange if it has determined that the TXOP that initiated the frame exchange has failed.

In order to efficiently utilize the scheduled subchannel allocation, the AP may schedule separate subchannel allocation frames for STAs that it intends to serve first and the STAs it intends to serve later within the TXOP. Note that the breaking of the subchannel allocation into multiple frames corresponding to STAs served first and served later may enable efficient utilization of the wireless medium. This may be for several reasons including the following. Firstly, the subchannel allocation frame for the later STAs can be transmitted during the channel switch time T required by the first STAs (which would otherwise need transmission of unnecessary padding bits). Secondly, since the STAs served later are served after the MPDUs sent to the first STAs, no padding is required to be provided to them.

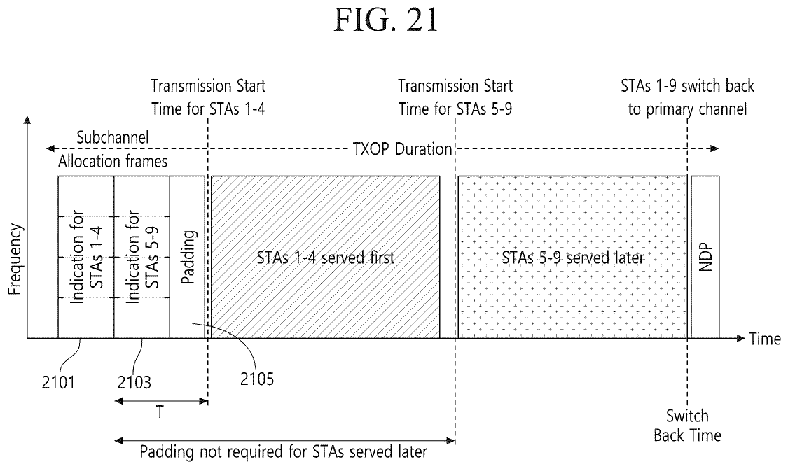

These benefits are exemplified pictorially in FIG. 21. In fact, if an AP intends to serve a set of STAs within a TXOP, the AP may decide to serve the STAs which have the shortest Channel Switch Time first and allocate all the other STAs to be served later in the TXOP. The AP may also prefer to reserve the primary channel for allocation to legacy STAs and STAs which are not DSO capable and may prefer to assign DSO STAs to non-primary channels, if available within a TXOP.

FIG. 21 illustrates the benefits of using separate Subchannel Allocation frames for the STAs served first and STAs served later within the TXOP, respectively in accordance with an embodiment. In particular, the AP transmits an allocation frame 2101 with indication for STAs 1-4, and then transmits an allocation frame 2103 with indications for STAs 5-9. The AP then transmits some padding 2105 until the transmission start time for STAs 1-4, after which these STAs 1-4 are served first. Then at the transmission start time for STAs 5-9, these STAs 5-9 are served, after which STAs 1-9 switch back to the primary channel at the switch back time, after which NDP are transmitted on the channel.

In some embodiments, the Subchannel Allocation frame may allocate RUs to one or more DSO STAs that are meant for being used by the DSO STAs for peer-to-peer communication with another STA. In this case, the subchannel allocation frame may include one or more of the following indications described below.

An indication that the RU allocation being made to the STA is a resource that is being shared with the STA for its own use for peer-to-peer communication. This can be included, for example, in a P2P subfield present in the user-specific field (or User Info field) addressed to that STA in the Subchannel Allocation frame.

An indication of the RU allocation duration, i.e., the duration for which the STA is allowed to use the shared resource for its P2P communication. This can be, for example, of the same length or shorter than the TXOP duration obtained by the AP. This can be indicated in an Allocation Duration field which may be assigned the units of transmit units (TUs) starting from the time of transmission of the Subchannel Allocation frame.

An indication of the other STAs who have been assigned to the same sub-channel. In one case this indication may not be explicit and a DSO STA may obtain this information implicitly by parsing the user-specific fields corresponding to the other STAs in the Subchannel Allocation frame.

An indication of the transmission constraints that may be applicable for the transmission within the allocated resources. These can include, for example, transmit power limits, modulation and coding scheme limits, among others.

In some embodiments, the resources allocated to a DSO STA with a P2P subfield set to 1 may be used by the STA either for peer-to-peer communication or for transmitting uplink data to the AP. In certain embodiments, the DSO STA may first transmit a response frame to the Subchannel Allocation frame sent by the AP before starting the P2P communication in the allocated resources. In certain embodiments, the DSO STA may not be required to transmit a response frame to the Subchannel Allocation frame sent by the AP.

In some embodiments, the RUs that are allocated by an AP to DSO STAs using the Subchannel Allocation frame may be within the bandwidth of the TXOP obtained by the AP. In some embodiments, the RUs allocated by an AP to DSO STAs using the Subchannel Allocation frame can be within the time or bandwidth resources shared with the AP via a TXOP sharing procedure or some multi-AP coordination procedure. This can be, for example, for the purpose of channel sensing on a secondary channel to obtain medium synchronization.

In some embodiments, the RUs allocated by an AP to DSO STAs using the Subchannel Allocation frame can be outside of the TXOP bandwidth and can be provided by the AP to the DSO STAs for the purpose of peer-to-peer communication, channel sensing on a secondary channel to obtain medium synchronization, communicating with a neighbor AP who obtained the TXOP on those RUs among others. In this case the AP may not provide TXOP protection for the time needed by these DSO STAs to perform the channel switch.

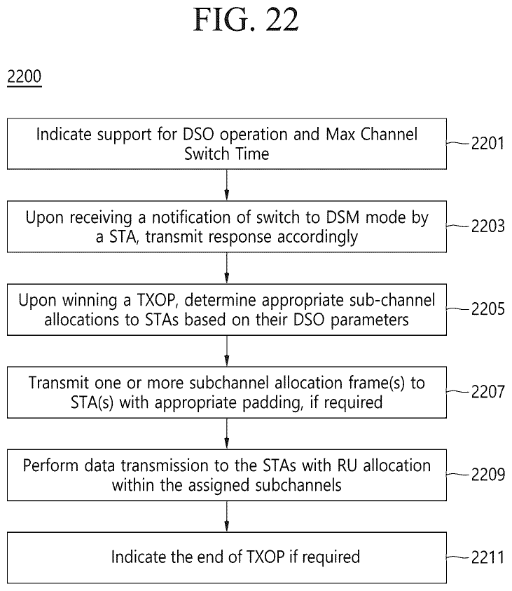

FIG. 22 illustrates a flow chart of an example processes by an AP for supporting DSO operation with pre-allocation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 22 illustrates operations performed in an AP, such as the AP illustrated in FIG. 3.

The process 2200 may begin in operation 2201. In operation 2201, the AP sends a frame to one or more associated STAs that indicates support for DSO operation and a Max channel switch time. In some embodiments, the AP may indicate if it supports an associated STA using a DSO Support field in a UHR Capabilities element that it transmits in Beacon frames and/or Probe Response frames. In some embodiments, the maximum allowed channel switch time for DSO may be predetermined and so this field may not be present. In some embodiments, there may be a DSO Preallocation Support field that indicates if the AP supports DSO sub-band pre-allocation, where pre-allocation may refer to allocating the sub-band to an STA that can be served at a later time within a TXOP.

In operation 2203, the AP receives a notification of switch to DSM mode by an STA. Upon receiving a notification of switch to DSM mode by an STA, the AP transmits a response accordingly. In some embodiments, the notification may be included in a notification frame from an STA. In some embodiments, a mode switch may be performed independently for each link. In certain embodiments, the mode switch may be performed jointly for one or more links. In some embodiments, the response may be a response Notification frame that confirms the mode switch. In the response frame, the AP may reject a switch to DSO mode, for example, if the channel switch time indicated by the STA is too long.

In operation 2205, the AP, upon winning a TXOP, determines appropriate sub-channel allocations to the STAs based on their DSO parameters. In some embodiments, the AP may transmit a CTS-to-Self frame in a duplicate PPDU format to protect all sub-channels where it has won the channel access.

In operation 2207, the AP transmits one or more subchannel allocation frame(s) to the STA(s) with appropriate padding if required. In some embodiments, the AP may transmit a frame to indicate the STA(s) with which it intends to perform frame exchanges on the non-primary channels within the TXOP. The frame may include an indication. The indication may include an AID of the non-AP STAs the AP intends to serve. The indications may include a start time of transmission of PPDUs or trigger frames to the STAs. The indication may include whether an addressed non-AP STA is expected to send a response frame. The indication may include the allocation of Rus where an addressed non-AP STA is expected to send the response if it is solicited. The indication may include the allocation of Rus or sub-channels where the AP intends to serve the non-AP STAs. The indication may include the switch back time after which the STAs are expected to return to the base primary channel.

In operation 2209, the AP performs data transmission to the STAs with the RU allocation within the assigned subchannels. In some embodiments, the AP may transmit PPDUs to the STAs.

In operation 2211, the AP indicates the end of the TXOP if required. In some embodiments, the AP may end data transmission to the STAs before the end of the TXOP to enable the STAs to perform channel switch back to the primary channel without loss of medium synchronization.

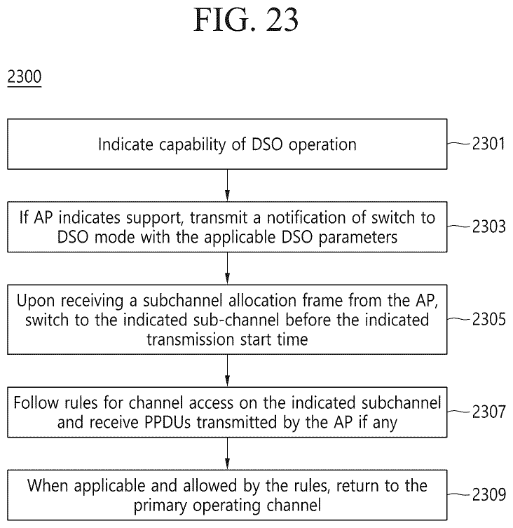

FIG. 23 illustrates a flow chart of an example process performed by a non-AP STA for operating in DSO mode with pre-allocation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 23 illustrates operations performed in a non-AP MLD, such as the non-AP STA illustrated in FIG. 3.

The process 2300 may begin in operation 2301. In operation 2301, the non-AP STA indicates capability of DSO operation. In some embodiments, a non-AP MLD may indicate if all its STAs support operating in DSO mode, using a DSO Support subfield in a UHR Capabilities element that is transmitted in a Probe Request frames and/or Association Response frames. In some embodiments, the non-AP STA may indicate a channel switch time for its DSO operation within the UHR Capabilities element. In some embodiments, there may be a DSO Preallocation Support field that indicates if the non-AP STA supports DSO sub-band pre-allocation, where pre-allocation refers to allocating the sub-band to a STA that can be served at a later time within the TXOP.

In operation 2303, the non-AP STA transmits, if the AP indicates support, a notification of switch to DSO mode with the applicable DSO parameters. In some embodiments, the notification may be transmitted in a Notification frame to the AP. In some embodiments, the mode switch may be performed independently for each link. In certain embodiments, the mode switch may be performed jointly for one or more links.

In operation 2305, the non-AP STA, upon receiving a subchannel allocation frame from the AP, switches to the indicated sub-channel before the indicated transmission start time. In some embodiments, the non-AP STA may immediately switch to the indicated sub-channel upon successfully receiving the subchannel allocation frame. In certain embodiments, the non-AP STA may ensure that it switches to the indicated sub-channel at or before the indicated transmission start time or the delayed ACK transmission time. If required, the non-AP STA may transmit an ACK or response frame at the indicated time.

In operation 2307, the non-AP STA follows the rules for the channel access on the indicated subchannel and receives PPDUs transmitted by the AP if any. In some embodiments, the non-AP STA may remain in the subchannel till the end of the TXOP or till the switch back time duration indicated by the AP. In some embodiments, the non-AP STA may determine the appropriate switch back time based on an indication of the end of the TXOP time and its own channel switch time.

In operation 2309, the non-AP STA returns, when applicable and allowed by the rules, to the primary operating channel. In some embodiments, if the non-AP STA that switches to an indicated sub-channel observed the channel to be IDLE for more than a threshold time, it may switch back immediately after that to the primary channel. In some embodiments, if the non-AP STA that switches to an indicated sub-channel observes a PPDU on that sub-channel that corresponds to another BSS or if neither the transmit address nor receive address of the PPDU correspond to the AP, it may immediately switch back to the primary channel.

In some embodiments, the subchannel allocation for all the UHR STAs that are expected to be served by an AP within a TXOP can be indicated in a single subchannel allocation frame. In certain embodiments, the Transmission Start Time may not be indicated in the frame. In some embodiments, the Transmission Start Time can be set to the time when the STAs to be served first will be served. In certain embodiments, a one-bit indication may be provided for each STA to indicate if the STA will be served immediately or later. The AP may transmit some signal on the wireless medium on all the bands of the TXOP for sufficient time T such that the indicated STAs may successfully perform the channel switch to their indicated subchannels. In certain embodiments, after the time T the AP may solicit a response frame from all or some of the STAs addressed in the subchannel allocation frame. After that, the AP may schedule triggered uplink or downlink data traffic to the STAs. In some embodiments, the time T may be greater than or equal to the maximum of the Channel Switch Times corresponding to the STAs that the AP intends to serve first within the TXOP. In certain embodiments, a Padding field that precedes the frame check sequence (FCS) may be used in the subchannel allocation frame as the signal that occupies and reserves the medium for the time T. In some embodiments, to enable successful reception of the frame and perform FCS check, a padding can be provided after the FCS field using, for example, the packet extension field. In some embodiments, a follow-up frame, such as a QoS Null frame, or a CTS-to-self frame, or frames addressed to other STAs which are already capable of reception etc. can be transmitted by the AP after the subchannel allocation frame, to keep the medium occupied for the time T.

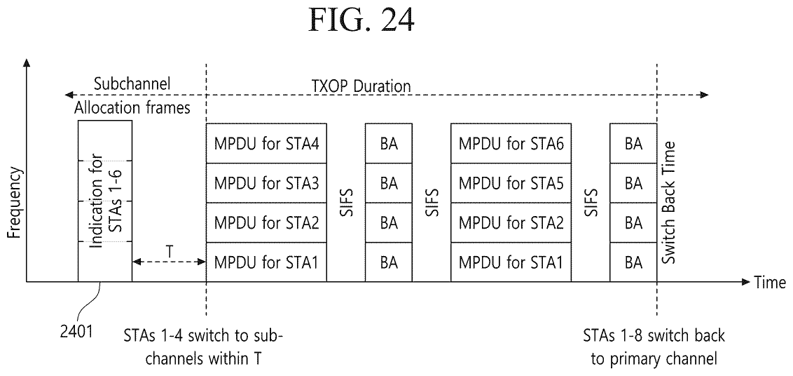

FIG. 24 illustrates sub-channel allocation by the AP in the beginning of a TXOP to all the DSO STAs that are served within the TXOP in accordance with an embodiment. As illustrated, during the TXOP duration, the AP transmits a Subchannel Allocation Frame 2401 with indications for STAs 1-6. Accordingly, STAs 1-4 switch to the sub-channels within time T. MPDUs are transmitted for STAS 1-4, then a SIFS, then a block acknowledgement (BA), then a SIFS, then MPDUs are transmitted for STAs 1, 2, 5 and 6, then a SIFT, then a BA, after which STAs 1-6 switch back to the primary channel.

Embodiments in accordance with this disclosure allow for utilizing a full available bandwidth provided by an AP by allocating sub-channels to different non-AP STAs. In particular, as the maximum supported bandwidth for wireless systems keeps rising, the AP bandwidth may become much wider than the current operating bandwidth each STA operates on, e.g., 320 MHZ for AP and 80 MHz for STA. Accordingly, embodiments in accordance with this disclosure can perform DSO where different subchannels may be allocated to different non-AP STAs and an STA may switch to a new subchannel that is outside of its initial operating bandwidth to avoid wasting the additional bandwidth that may be otherwise available from an AP. DSO may improve network operations, including improved data transfer and bandwidth utilization.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, the AP comprising:
a memory; and
a processor coupled to the memory, the processor configured to:
obtain a transmission opportunity (TXOP) or service period (SP);
transmit, to a first station (STA) during the TXOP or the SP, an indication allocating a first subchannel among one or more subchannels to the first STA at a first transmission start time, wherein the first subchannel is out of an operating channel width of the first STA;
transmit, to a second STA during the TXOP or the SP, an indication allocating a second subchannel among the one or more subchannels to the second STA at a second transmission start time, wherein the second subchannel is out of an operating channel width of the second STA;
transmit, to the first STA during the TXOP or the SP on the first subchannel, a first frame at the first transmission start time; and
transmit, to the second STA during the TXOP or the SP on the second subchannel, a second frame at the second transmission start time.

2. The AP of claim 1, wherein the processor is further configured to receive a third frame, from the first STA, wherein the third frame includes information associated with at least one of:
a capability of supporting allocation of a subchannel outside of the operating channel width of the first STA, or
a channel switch time required by the first STA to switch to an allocated channel, wherein the first transmission start time is determined based on the channel switch time.

3. The AP of claim 1, wherein the indications allocating the first subchannel and the second subchannel are transmitted within a third frame, wherein the processor is further configured to, at a beginning of the TXOP or the SP, transmit the third frame indicating at least one of:
one or more identifiers of associated STAs the AP intends to serve within the TXOP or the SP,
a transmission start time applicable to each of the identified one or more STAs,
an allocation of a sub-channel for transmission of a response to the third frame, if the response is solicited from the one or more identified STAs,
allocations of one or more sub-channels allocated to each of the one or more identified STAs for transmissions within the TXOP or the SP,
allocations of one or more 20 MHz channels to be used for preamble detection by each of the one or more identified STAs, or
a switch back time after which the one or more identified STAs are expected to return to a primary channel.

4. The AP of claim 1, wherein the processor is further configured to:
transmit, to a third STA during the TXOP or the SP, an indication allocating the second subchannel among the one or more subchannels to the third STA at the first transmission start time; and
transmit, to the third STA during the TXOP or the SP on the second subchannel, a third frame at the first transmission start time.

5. The AP of claim 1, wherein the processor is further configured to, before the first transmission start time, transmit one or more of:
a padding field within a third frame, wherein the third frame includes the indication allocating the first subchannel to the first STA,
a fourth frame, wherein the fourth frame includes the indication allocating the second subchannel among the one or more subchannels to the second STA, or
a fifth frame, wherein the fifth frame is a data frame or a null data packet with padding.

6. The AP of claim 1, wherein the processor is further configured to end frame transmissions to the one or more STAs before the end of the TXOP to enable the one or more STAs to switch back to the primary channel.

7. The AP of claim 1, wherein the processor is further configured to transmit a third frame to indicate a capability to support allocation of a subchannel outside of an operating channel width of an associated STA, wherein the associated STA can be allocated one or more subchannels of the TXOP or the SP that are outside of the associated STA's operating channel width.

8. The AP of claim 1, wherein a third STA is operating in enhanced multi-link single radio (EMLSR) mode or enhanced multi-link multi-radio (EMLMR) mode, wherein the processor is configured to:
exclude the third STA from operation on a subchannel outside of an operating channel width of the third STA, or
determine a transmission start time for the third STA based on a channel switch time required by the third STA and a padding delay required by the third STA for EMLSR or EMLMR operation, and transmit an indication of a subchannel allocation to the third STA in an EMLSR or EMLMR control frame.

9. The AP of claim 1, wherein the indication allocating the first subchannel among the one or more subchannels to the first STA is included in a third frame, wherein the third frame comprises at least one of:
whether the first subchannel can be used by the first STA for peer-to-peer transmissions,
a duration for which the first subchannel can be used for peer-to-peer transmissions,
an identifier of other STA allocated to the same subchannel by the AP, or
a transmit power and modulation and coding scheme restrictions applicable for the peer-to-peer transmissions.

10. A non-access point (AP) station (STA) in a wireless network, the non-AP STA comprising:
a memory; and
a processor coupled to the memory, the processor configured to:
transmit, to an AP, a first frame indicating a capability to operate one or more subchannels out of the primary channel;
receive, during a TXOP or SP, a second frame from the AP that indicates a subchannel allocation and a transmission start time; and
switch to the indicated subchannel before the transmission start time, wherein the indicated subchannel is outside of the operating channel width of the non-AP STA.

11. The non-AP STA of claim 10, wherein the processor is further configured to receive, on the subchannel starting at the transmission start time, frames from the AP.

12. The non-AP STA of claim 10, wherein the processor is further configured to transmit to the AP a third frame indicating at least one of:
enablement or disablement of supporting operation on a subchannel outside of the operating channel width by the non-AP STA,
one or more supported subchannels outside the operating channel width by the non-AP STA,
bandwidth, spatial stream and modulation and coding scheme supported by the non-AP STA when receiving transmissions outside the operating channel width, or
capability of the non-AP STA to be pre-allocated a subchannel, wherein the transmission start time to the non-AP STA may not be immediately after the indication of the allocation.

13. The non-AP STA of claim 10, wherein the processor is further configured to, upon receiving the second frame, immediately switching to the indicated subchannel or switching to the indicated subchannel at or before the transmission start time.

14. The non-AP STA of claim 10, wherein the processor is further configured to switch back to a primary channel based on at least one of:
an indication of the end of the TXOP or the SP time and the channel switch time needed by the non-AP STA to switch channels;
a detection of the indicated subchannel to be idle for more than a threshold time after the indicated transmission start time;
a detection of a particular frame on the indicated subchannel that corresponds to another basic service set (BSS) or that the transmit address or receive address of the particular frame does not correspond to the AP; or
a determination that no frames are received from the AP within a threshold time after the indicated start time.

15. The non-AP STA of claim 10, wherein the process is further configured to perform preamble detection on a 20 MHz channel that is determined based on the subchannel allocated to the non-AP STA.

16. A computer-implemented method for an access point (AP) in a wireless network, the method comprising:
obtaining a transmission opportunity (TXOP) or service period (SP);
transmitting, to a first station (STA) during the TXOP or the SP, an indication allocating a first subchannel among one or more subchannels to the first STA at a first transmission start time, wherein the first subchannel is out of an operating channel width of the first STA;
transmitting, to a second STA during the TXOP or the SP, an indication allocating a second subchannel among the one or more subchannels to the second STA at a second transmission start time, wherein the second subchannel is out of an operating channel width of the second STA;
transmitting, to the first STA during the TXOP or the SP on the first subchannel, a first frame at the first transmission start time; and
transmitting, to the second STA during the TXOP or the SP on the second subchannel, a second frame at the second transmission start time.

17. The computer-implemented method of claim 16, further comprising:
receiving a third frame, from the first STA, wherein the third frame includes information associated with at least one of:
a capability of supporting allocation of a subchannel outside of the operating channel width of the first STA, or
a channel switch time required by the first STA to switch to an allocated channel, wherein the first transmission start time is determined based on the channel switch time.

18. The computer-implemented method of claim 16, wherein the indications allocating the first subchannel and the second subchannel are transmitted within a third frame, wherein the method further comprises:
at a beginning of the TXOP or the SP, transmitting the third frame indicating at least one of:
one or more identifiers of associated STAs the AP intends to serve within the TXOP or the SP;
a transmission start time applicable to each of the identified one or more STAs, an allocation of a sub-channel for transmission of a response to the third frame, if the response is solicited from the one or more identified STAs,
allocations of one or more sub-channels allocated to each of the one or more identified STAs for transmissions within the TXOP or the SP,
allocations of one or more 20 MHz channels to be used for preamble detection by each of the one or more identified STAs, and
a switch back time after which the one or more identified STAs are expected to return to a primary channel.

19. The computer-implemented method of claim 16, further comprising:
transmitting, to a third STA during the TXOP or the SP, an indication allocating the second subchannel among the one or more subchannels to the third STA at the first transmission start time; and
transmitting, to the third STA during the TXOP or the SP on the second subchannel, a third frame at the first transmission start time.

20. The computer-implemented method of claim 16, further comprising, before the first transmission start time, transmitting at least one of:
a padding field within a third frame, wherein the third frame includes the indication allocating the first subchannel to the first STA,
a fourth frame, wherein the fourth frame includes the indication allocating the second subchannel among the one or more subchannels to the second STA, or
a fifth frame, wherein the fifth frame is a data frame or a null data packet with padding.
